(19) United States
(12) Patent Application Publication
(10) Pub. No.: US 2025/0219792 A1
(43) Pub. Date: Jul. 3, 2025

(54) TECHNIQUES FOR BASEBAND FREQUENCY SHIFTING

(71) Applicant: QUALCOMM INCORPORATED, San Diego, CA (US)

(72) Inventors: Mingxi Yin, Beijing (CN); Chao Wei, Beijing (CN); Kangqi Liu, San Diego, CA (US); Min Huang, Beijing (CN); Rui Hu, Beijing (CN); Hao Xu, Beijing (CN)

(21) Appl. No.: 18/851,664

(22) PCT Filed: Jun. 1, 2022
(86) PCT No.: PCT/CN2022/096557

§ 371 Date: Sep. 26, 2024

(51) Int. Cl. H04L 5/00; H04W 72/0453; H04W 72/232

(52) U.S. Cl. CPC H04L 5/0053; H04W 72/0453; H04W 72/232

(57) ABSTRACT

Methods, systems, and devices for wireless communication are described. A passive user equipment (UE) may transmit an indication of a baseband frequency shift type supported by the passive UE for backscatter communications. The baseband frequency shift type may include one or both of a single-side frequency shift or a double-side frequency shift. A network entity may determine a frequency domain resource allocation (FDRA) for the passive UE based on receiving the indication. The network entity may transmit an indication of the FDRA to the passive UE. The FDRA may correspond to the baseband frequency shift type supported by the passive UE. The passive UE may transmit one or more backscatter communications based on the FDRA signaled by the network entity. The one or more backscatter communication s may be frequency shifted according to the baseband frequency shift type supported by the passive UE.

### CROSS REFERENCE

The present Application is a 371 national stage filing of International PCT Application No. PCT/CN2022/096557 by Yin et al. entitled “TECHNIQUES FOR BASEBAND FREQUENCY SHIFTING,” filed Jun. 1, 2022, which is assigned to the assignee hereof, and which is expressly incorporated by reference in its entirety herein.

### TECHNICAL FIELD

The following relates to wireless communication, including techniques for baseband frequency shifting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support passive communications. However, some passive communications may be associated with poor spectral efficiency and relatively high communication resource overhead.

### SUMMARY

The present disclosure relates to improved methods, systems, devices, and apparatuses that support techniques for baseband frequency shifting. For example, the techniques described herein provide for improving the spectral efficiency of backscatter communications at a passive user equipment (UE). In accordance with aspects of the present disclosure, a passive (e.g., low-power, ambient power-enabled) UE may transmit an indication of a baseband frequency shift type supported by the passive UE for backscatter communications. The baseband frequency shift type may include one or both of a single-side frequency shift or a double-side frequency shift. A network entity may determine a frequency domain resource allocation (FDRA) for the passive UE based on receiving the indication. The network entity may transmit an indication of the FDRA to the passive UE. The FDRA may correspond to the baseband frequency shift type supported by the passive UE. The passive UE may transmit one or more backscatter communications based on the FDRA signaled by the network entity. The one or more backscatter communications may be frequency shifted according to the baseband frequency shift type supported by the passive UE.

A method for wireless communication at a UE is described. The method may include transmitting an indication of a baseband frequency shift type supported by the UE for backscatter communications, where the baseband frequency shift type includes one or both of a single-side frequency shift or a double-side frequency shift. The method may further include receiving a control message that indicates a FDRA for backscatter communications at the UE, where the FDRA corresponds to the baseband frequency shift type supported by the UE. The method may further include transmitting one or more backscatter communications based on the FDRA indicated by the control message, where the one or more backscatter communications are frequency shifted according to the baseband frequency shift type supported by the UE.

An apparatus for wireless communication at a UE is described. The apparatus may include at least one processor and memory coupled (e.g., operatively, communicatively, functionally, electronically, or electrically) to the at least one processor, the memory storing instructions executable by the at least one processor to cause the UE to transmit an indication of a baseband frequency shift type supported by the UE for backscatter communications, where the baseband frequency shift type includes one or both of a single-side frequency shift or a double-side frequency shift. The instructions may be further executable by the at least one processor to receive a control message that indicates a FDRA for backscatter communications at the UE, where the FDRA corresponds to the baseband frequency shift type supported by the UE. The instructions may be further executable by the at least one processor to transmit one or more backscatter communications based on the FDRA indicated by the control message, where the one or more backscatter communications are frequency shifted according to the baseband frequency shift type supported by the UE.

Another apparatus for wireless communication at a UE is described. The apparatus may include means for transmitting an indication of a baseband frequency shift type supported by the UE for backscatter communications, where the baseband frequency shift type includes one or both of a single-side frequency shift or a double-side frequency shift. The apparatus may further include means for receiving a control message that indicates a FDRA for backscatter communications at the UE, where the FDRA corresponds to the baseband frequency shift type supported by the UE. The apparatus may further include means for transmitting one or more backscatter communications based on the FDRA indicated by the control message, where the one or more backscatter communications are frequency shifted according to the baseband frequency shift type supported by the UE.

A non-transitory computer-readable medium storing code for wireless communication at a UE is described. The code may include instructions executable by at least one processor to cause the UE to transmit an indication of a baseband frequency shift type supported by the UE for backscatter communications, where the baseband frequency shift type includes one or both of a single-side frequency shift or a double-side frequency shift. The instructions may be further executable by the at least one processor to cause the UE to receive a control message that indicates a FDRA for backscatter communications at the UE, where the FDRA corresponds to the baseband frequency shift type supported by the UE. The instructions may be further executable by the at least one processor to cause the UE to transmit one or more backscatter communications based on the FDRA indicated by the control message, where the one or more backscatter communications are frequency shifted according to the baseband frequency shift type supported by the UE.

In some examples of the method, apparatuses, and non-transitory computer-readable medium described herein, transmitting the indication of the baseband frequency shift type supported by the UE may include operations, features, means, or instructions for transmitting a report that indicates a set of baseband frequencies supported by the UE in connection with the baseband frequency shift type supported by the UE.

Some examples of the method, apparatuses, and non-transitory computer-readable medium described herein may further include operations, features, means, or instructions for receiving an indication of a selected baseband frequency from the set of baseband frequencies indicated by the report, where the one or more backscatter communications are frequency shifted according to the selected baseband frequency.

Some examples of the method, apparatuses, and non-transitory computer-readable medium described herein may further include operations, features, means, or instructions for transmitting at least one backscatter communication based on a default FDRA prior to transmitting the report, where the at least one backscatter communication is frequency shifted according to the baseband frequency shift type supported by the UE.

Some examples of the method, apparatuses, and non-transitory computer-readable medium described herein may further include operations, features, means, or instructions for receiving downlink control information (DCI) that indicates an updated FDRA for backscatter communications at the UE, where the updated FDRA is based on the report.

In some examples of the method, apparatuses, and non-transitory computer-readable medium described herein, the report indicates start frequencies associated with the set of baseband frequencies, step frequencies associated with the set of baseband frequencies, stop frequencies associated with the set of baseband frequencies, each frequency in the set of baseband frequencies, or a combination thereof.

In some examples of the method, apparatuses, and non-transitory computer-readable medium described herein, the report may be transmitted via a default baseband frequency and the set of baseband frequencies indicated by the report may be associated with a baseband frequency source type of the UE.

Some examples of the method, apparatuses, and non-transitory computer-readable medium described herein may further include operations, features, means, or instructions for receiving DCI that indicates a default FDRA for backscatter communications at the UE.

Some examples of the method, apparatuses, and non-transitory computer-readable medium described herein may further include operations, features, means, or instructions for receiving a query message associated with a double-side frequency shift type or a single-side frequency shift type, where transmitting the indication of the baseband frequency shift type supported by the UE is based on the query message.

In some examples of the method, apparatuses, and non-transitory computer-readable medium described herein, receiving the control message may include operations, features, means, or instructions for receiving an indication of frequency shift information for different frequency shift values or different frequency shift types supported by other UEs, where the frequency shift information indicates one or more of a frequency, a frequency index, a frequency shift type, an index associated with a frequency shift type, or a sign of the frequency shift type used for backscatter communications at the other UEs.

In some examples of the method, apparatuses, and non-transitory computer-readable medium described herein, transmitting the one or more backscatter communications may include operations, features, means, or instructions for transmitting, in accordance with a frequency shift hopping scheme, a first backscatter communication that is frequency shifted according to a negative single-side frequency shift and a second backscatter communication that is frequency shifted according to a positive single-side frequency shift.

In some examples of the method, apparatuses, and non-transitory computer-readable medium described herein, transmitting the one or more backscatter communications may include operations, features, means, or instructions for transmitting a first portion of a bit sequence that is frequency shifted according to a negative single-side frequency shift and transmitting a second portion of the bit sequence that is frequency shifted according to a positive single-side frequency shift, where the bit sequence includes data or control information.

In some examples of the method, apparatuses, and non-transitory computer-readable medium described herein, the FDRA indicates a frequency hopping scheme for backscatter communications at the UE.

In some examples of the method, apparatuses, and non-transitory computer-readable medium described herein, transmitting the one or more backscatter communications may include operations, features, means, or instructions for receiving a downlink shared channel transmission via a downlink baseband frequency and operations, features, means, or instructions for signaling the one or more backscatter communications by frequency shifting the downlink shared channel transmission with respect to the downlink baseband frequency and modifying one or both of an amplitude or a phase of the downlink shared channel transmission.

In some examples of the method, apparatuses, and non-transitory computer-readable medium described herein, transmitting the one or more backscatter communications may include operations, features, means, or instructions for receiving an uplink shared channel transmission via an uplink baseband frequency and operations, features, means, or instructions for signaling the one or more backscatter communications by frequency shifting the uplink shared channel transmission with respect to the uplink baseband frequency and modifying one or both of an amplitude or a phase of the uplink shared channel transmission.

In some examples of the method, apparatuses, and non-transitory computer-readable medium described herein, the indication of the baseband frequency shift type may be transmitted in response to a trigger message.

A method for wireless communication at a network entity is described. The method may include obtaining an indication of a baseband frequency shift type supported by a UE for backscatter communications, where the baseband frequency shift type includes one or both of a single-side frequency shift or a double-side frequency shift. The method may further include outputting a control message that indicates a FDRA for backscatter communications at the UE, where the FDRA corresponds to the baseband frequency shift type supported by the UE. The method may further include obtaining one or more backscatter communications based on the FDRA indicated by the control message, where the one or more backscatter communications are frequency shifted according to the baseband frequency shift type supported by the UE.

An apparatus for wireless communication at a network entity is described. The apparatus may include at least one processor and memory coupled (e.g., operatively, communicatively, functionally, electronically, or electrically) to the at least one processor, the memory storing instructions executable by the at least one processor to cause the network entity to obtain an indication of a baseband frequency shift type supported by a UE for backscatter communications, where the baseband frequency shift type includes one or both of a single-side frequency shift or a double-side frequency shift. The instructions may be further executable by the at least one processor to output a control message that indicates a FDRA for backscatter communications at the UE, where the FDRA corresponds to the baseband frequency shift type supported by the UE. The instructions may be further executable by the at least one processor to obtain one or more backscatter communications based on the FDRA indicated by the control message, where the one or more backscatter communications are frequency shifted according to the baseband frequency shift type supported by the UE.

Another apparatus for wireless communication at a network entity is described. The apparatus may include means for obtaining an indication of a baseband frequency shift type supported by a UE for backscatter communications, where the baseband frequency shift type includes one or both of a single-side frequency shift or a double-side frequency shift. The apparatus may further include means for outputting a control message that indicates a FDRA for backscatter communications at the UE, where the FDRA corresponds to the baseband frequency shift type supported by the UE. The apparatus may further include means for obtaining one or more backscatter communications based on the FDRA indicated by the control message, where the one or more backscatter communications are frequency shifted according to the baseband frequency shift type supported by the UE.

A non-transitory computer-readable medium storing code for wireless communication at a network entity is described. The code may include instructions executable by at least one processor to cause the network entity to obtain an indication of a baseband frequency shift type supported by a UE for backscatter communications, where the baseband frequency shift type includes one or both of a single-side frequency shift or a double-side frequency shift. The instructions may be further executable by the at least one processor to cause the network entity to output a control message that indicates a FDRA for backscatter communications at the UE, where the FDRA corresponds to the baseband frequency shift type supported by the UE. The instructions may be further executable by the at least one processor to cause the network entity to obtain one or more backscatter communications based on the FDRA indicated by the control message, where the one or more backscatter communications are frequency shifted according to the baseband frequency shift type supported by the UE.

In some examples of the method, apparatuses, and non-transitory computer-readable medium described herein, obtaining the indication of the baseband frequency shift type may include operations, features, means, or instructions for obtaining a report that indicates a set of baseband frequencies supported by the UE in connection with the baseband frequency shift type supported by the UE.

Some examples of the method, apparatuses, and non-transitory computer-readable medium described herein may further include operations, features, means, or instructions for selecting a baseband frequency from the set of baseband frequencies indicated by the report and outputting an indication of the selected baseband frequency, where the one or more backscatter communications are frequency shifted according to the selected baseband frequency.

Some examples of the method, apparatuses, and non-transitory computer-readable medium described herein may further include operations, features, means, or instructions for obtaining at least one backscatter communication based on a default FDRA prior to obtaining the report, where the at least one backscatter communication is frequency shifted according to the baseband frequency shift type supported by the UE.

Some examples of the method, apparatuses, and non-transitory computer-readable medium described herein may further include operations, features, means, or instructions for updating a default FDRA for the UE based on the report.

Some examples of the method, apparatuses, and non-transitory computer-readable medium described herein may further include operations, features, means, or instructions for outputting a query message associated with a double-side frequency shift type or a single-side frequency shift type, where obtaining the indication of the baseband frequency shift type supported by the UE is based on the query message.

In some examples of the method, apparatuses, and non-transitory computer-readable medium described herein, outputting the control message may include operations, features, means, or instructions for outputting an indication of frequency shift information for different frequency shift values or different frequency shift types supported by other UEs, where the frequency shift information indicates one or more of a frequency, a frequency index, a frequency shift type, an index associated with a frequency shift type, or a sign of the frequency shift type used for backscatter communications at the other UEs.

Some examples of the method, apparatuses, and non-transitory computer-readable medium described herein may further include operations, features, means, or instructions for obtaining a first portion of a bit sequence that is frequency shifted according to a negative single-side frequency shift and operations, features, means, or instructions for obtaining a second portion of the bit sequence that is frequency shifted according to a positive single-side frequency shift, where the bit sequence includes data or control information.

Some examples of the method, apparatuses, and non-transitory computer-readable medium described herein may further include operations, features, means, or instructions for decoding the bit sequence based on a first received power corresponding to the first portion of the bit sequence and on a second received power corresponding to the second portion of the bit sequence.

Some examples of the method, apparatuses, and non-transitory computer-readable medium described herein may further include operations, features, means, or instructions for outputting a second control message that indicates a second FDRA for backscatter communications at a second UE, where at least a portion of the second FDRA overlaps with the FDRA indicated by the control message.

In some examples of the method, apparatuses, and non-transitory computer-readable medium described herein, obtaining the one or more backscatter communications may include operations, features, means, or instructions for obtaining a first backscatter communication based on the FDRA for backscatter communications at the UE, where the first backscatter communication is frequency shifted according to a single-side frequency shift with a frequency shift value. In some examples of the method, apparatuses, and non-transitory computer-readable medium described herein, obtaining the one or more backscatter communications may include operations, features, means, or instructions for obtaining a second backscatter communication based on the second FDRA for backscatter communications at the second UE, where the second backscatter communication is frequency shifted according to a double-side frequency shift with the frequency shift value.

Some examples of the method, apparatuses, and non-transitory computer-readable medium described herein may further include operations, features, means, or instructions for decoding a first portion of the second backscatter communication that is frequency shifted according to the double-side frequency shift and operations, features, means, or instructions for decoding the first backscatter communication that is frequency shifted according to the single-side frequency shift by subtracting a second portion of the second backscatter communication from the first backscatter communication, where the first backscatter communication overlaps with the second portion of the second backscatter communication in a time domain and a frequency domain.

### BRIEF DESCRIPTION OF THE DRAWINGS

FIGS. 1 and 2 illustrate examples of wireless communications systems that support techniques for baseband frequency shifting in accordance with one or more aspects of the present disclosure.

FIGS. 3 and 4 illustrate examples of resource diagrams that support techniques for baseband frequency shifting in accordance with one or more aspects of the present disclosure.

FIGS. 5 through 7 illustrate examples of process flows that support techniques for baseband frequency shifting in accordance with one or more aspects of the present disclosure.

FIGS. 8 and 9 show block diagrams of devices that support techniques for baseband frequency shifting in accordance with one or more aspects of the present disclosure.

FIG. 10 shows a block diagram of a communications manager that supports techniques for baseband frequency shifting in accordance with one or more aspects of the present disclosure.

FIG. 11 shows a diagram of a system including a device that supports techniques for baseband frequency shifting in accordance with one or more aspects of the present disclosure.

FIGS. 12 and 13 show block diagrams of devices that support techniques for baseband frequency shifting in accordance with one or more aspects of the present disclosure.

FIG. 14 shows a block diagram of a communications manager that supports techniques for baseband frequency shifting in accordance with one or more aspects of the present disclosure.

FIG. 15 shows a diagram of a system including a device that supports techniques for baseband frequency shifting in accordance with one or more aspects of the present disclosure.

FIGS. 16 through 19 show flowcharts illustrating methods that support techniques for baseband frequency shifting in accordance with one or more aspects of the present disclosure.

### DETAILED DESCRIPTION

Some wireless communications systems may support backscatter communications. Backscattering generally refers to the process of modulating data on a signal from another device. For example, a user equipment (UE) may receive an incoming physical downlink shared channel (PDSCH) or physical uplink shared channel (PUSCH) signal, and may backscatter (modulate) data on the incoming signal by changing an amplitude or phase of the incoming signal. The backscattered signal may be received and decoded by other communication devices. The UE may apply a frequency shift to the incoming signal such that the backscattered signal does not collide with other transmissions on the carrier frequency of the incoming signal.

Some passive (e.g., low-power) UEs may be capable of using different frequency shift types for backscatter communications. For example, some passive UEs may support one or more of a double-side frequency shift type or a single-side frequency shift type. Double-side frequency shifting may be associated with lower hardware complexity and cost (in comparison to single-side frequency shifting). However, backscattered signals that are single-side frequency shifted may span fewer frequency resources in comparison to backscattered signals that are double-side frequency shifted. As such, the number of frequency resources used for backscatter communications may depend on the frequency shift type used to transmit the backscatter communications. However, a network entity may be unable to consider the frequency shift type of a passive UE when allocating resources to the passive UE.

Aspects of the present disclosure provide for reporting or otherwise signaling support for different frequency shift types. For example, a passive UE may transmit a capability report that indicates one or more frequency shift types supported by the passive UE. The capability report may also indicate a number of baseband frequencies that the passive UE is capable of using for backscatter communications. In some examples, the passive UE may backscatter the capability report on another signal. After receiving the capability report, a network entity may select or update a frequency domain resource allocation (FDRA) for the passive UE, and may indicate this information to the passive UE via control signaling. Accordingly, the passive UE may use the indicated FDRA for subsequent backscatter communications.

In some examples, the network entity may transmit a query message to determine which passive UEs support a given frequency shift type (as opposed to receiving a capability report that indicates such information). For example, if the network entity transmits a query message associated with a single-side frequency shift type, the network entity may determine which passive UEs support the single-side frequency shift type by tracking which passive UEs respond to the query message. After obtaining frequency shift capability information from different passive UEs, the network entity may provide this information to other UEs (e.g., UEs that support New Radio (NR) communications) such that the other UEs can receive backscatter communications from the passive UEs.

Aspects of the present disclosure may be implemented to realize one or more of the following advantages. The techniques described herein may improve the spectral efficiency of backscatter communications in a wireless network. More specifically, the described techniques may enable a passive UE to signal support for different frequency shift types and baseband frequencies. A network entity may use this information to select or adjust an FDRA for backscatter communications at the passive UE. Allocating frequency resources according to frequency shift type may improve the spectral efficiency of backscatter communications at the passive UE by reducing the communication resource overhead of the associated FDRA.

Aspects of the disclosure are initially described in the context of wireless communications systems, resource diagrams, and process flows. Aspects of the disclosure are further illustrated by and described with reference to apparatus diagrams, system diagrams, and flowcharts that relate to techniques for baseband frequency shifting.

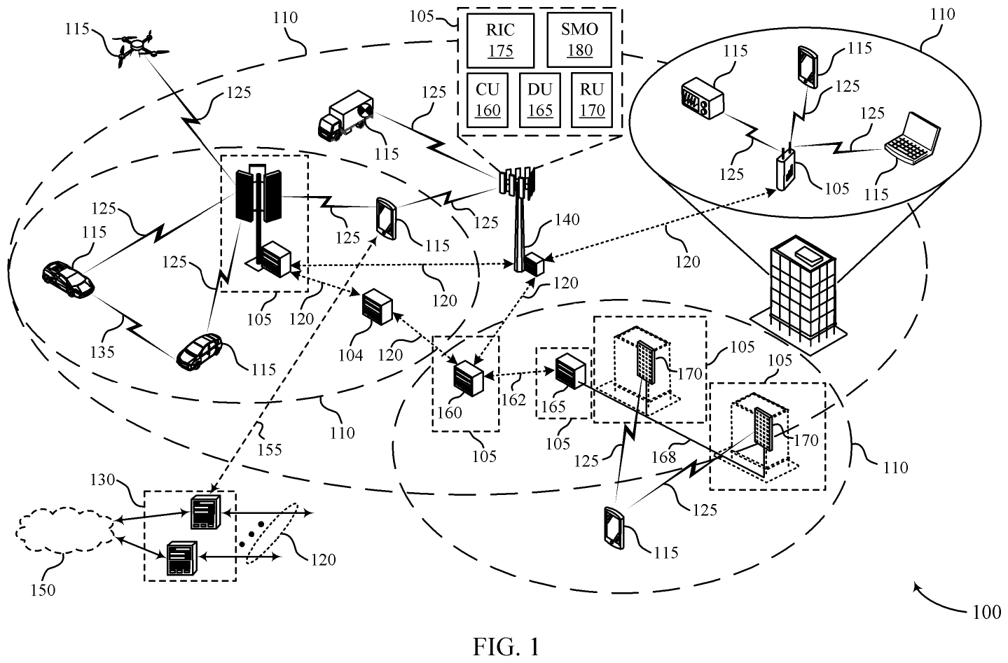

FIG. 1 illustrates an example of a wireless communications system 100 that supports techniques for baseband frequency shifting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160.

Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for baseband frequency shifting, as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia entertainment device (e.g., a radio, a Moving Picture Experts Group Layer-3 (MP3) player, or a video device), a camera, a gaming device, a navigation or positioning device (e.g., global navigation satellite system (GNSS) devices based on, for example, global positioning system (GPS), Beidou, global navigation satellite system (GLONASS), or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry such as a smart ring or a smart bracelet), a drone, a robot or robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor or actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or a machine type communication (MTC) device, which may be implemented in various articles such as appliances, drones, robots, vehicles, or meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. The techniques disclosed herein may be applicable to MTC or IoT UEs. MTC or IoT UEs may include MTC or enhanced MTC (eMTC), also referred to as category M (CAT-M) or category M1 UEs, NB-IoT (also referred to as CAT-NB1) UEs, as well as other types of UEs. eMTC and NB-IoT may refer to future technologies that are based on or evolve from these technologies. For example, eMTC may include further eMTC (FeMTC), enhanced further eMTC (eFeMTC), and massive MTC (mMTC), and NB-IoT may include enhanced NB-IoT (eNB-IoT), and further enhanced NB-IoT (FeNB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support backscatter communications between wireless devices. To perform backscatter communications, a UE 115 may be equipped with a receive antenna port circuit that includes a parallel equivalent circuit of an antenna and a load. When the antenna receives electromagnetic waves, power is transmitted from the antenna to the load, while a portion of the power is reflected from the load to the antenna with a reflection coefficient T_{b} given by Kurokawa's formula

$$( {T}_{b} = {\vert \frac{{Z}_{L} - {Z}_{A}^{*}}{{Z}_{L} + {Z}_{A}} \vert}^{2} ) .$$

The reflected power is radiated from the antenna, and may be referred to as backscatter. If the load impedance matches with the antenna impedance (e.g., Z_{L}=Z*_{A}), there is no backscatter power. By varying the load impedance Z_{L}, information can be transmitted with varied backscatter power by performing backscatter modulations (which multiply the incoming signal and the backscatter signal).

Backscatter communications systems may include a carrier emitter, a backscatter device, and a receiver that are connected by wireless channels g, h and f, respectively. The transmitter transmits a carrier wave (denoted by c). The backscatter signal is denoted by x. The resultant signal at the receiver is given by y=ghcx+fc+n, where n denotes additive white Gaussian noise. Passive radio frequency identification (RFID) is an industrial technology that utilizes backscatter communications. An RFID system may include a reader and passive tags. Passive RFID tags (which may not have a battery) are backscatter devices that use signals from an RFID reader to power up, decode signals from the RFID reader, and backscatter stored information. An antenna of the RFID tag may receive an electromagnetic wave, rectify the potential difference to direct current, charge a capacitor of the RFID tag, power up an integrated circuit of the RFID tag, demodulate and decode received signals, and transmit signals that are coded and modulated. Electronic Product Code (EPC) Class-1 Generation-2 (C1G2) is an example of a passive RFID protocol.

Backscatter communications may also be used for reduced capability (RedCap) applications, enhanced RedCap (eRedCap) applications, or ambient power-enabled IoT (also referred to herein as passive IoT) applications. Backscatter communications may provide greater power and flexibility for cellular systems that include distributed nodes like gNBs and UEs. Backscatter communications with multi-static networking (e.g., ambient backscatter) can provide greater coverage in comparison to passive RFID. In wireless communications systems that support NR communications, a network entity 105 or a UE 115 may be an RF source for backscatter communications. A UE 115 or a network entity 105 may receive NR communications or backscatter communications from other passive IoT devices. For example, a passive UE may backscatter (modulate) a signal on a carrier wave (CW) transmitted from a network entity 105 to a UE 115 (for uplink-based backscatter) or on a CW transmitted from a UE 115 to a network entity 105 (for downlink-based backscatter). Passive UEs can receive signals using envelope detection.

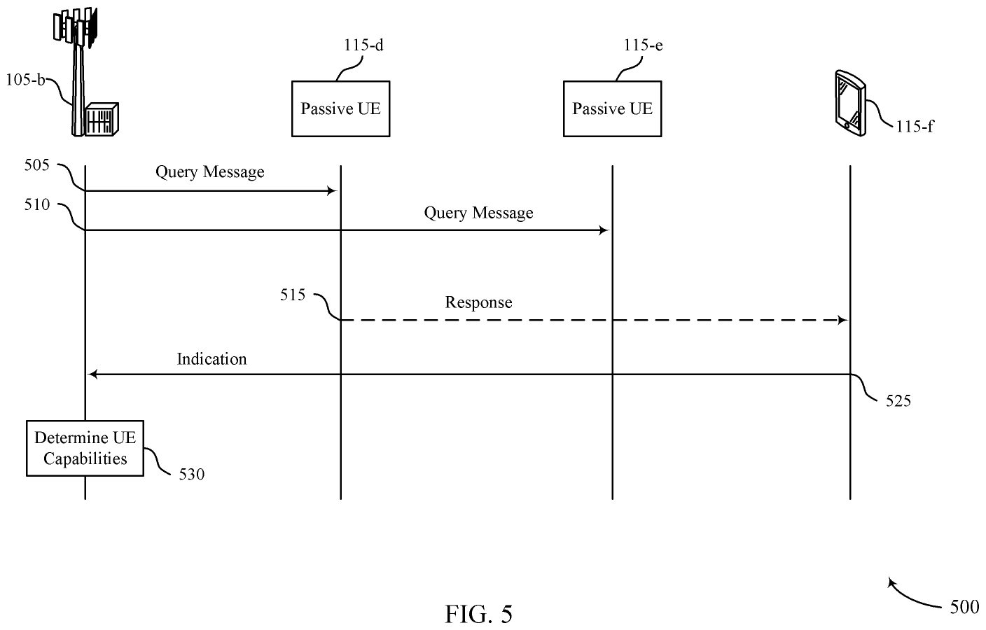

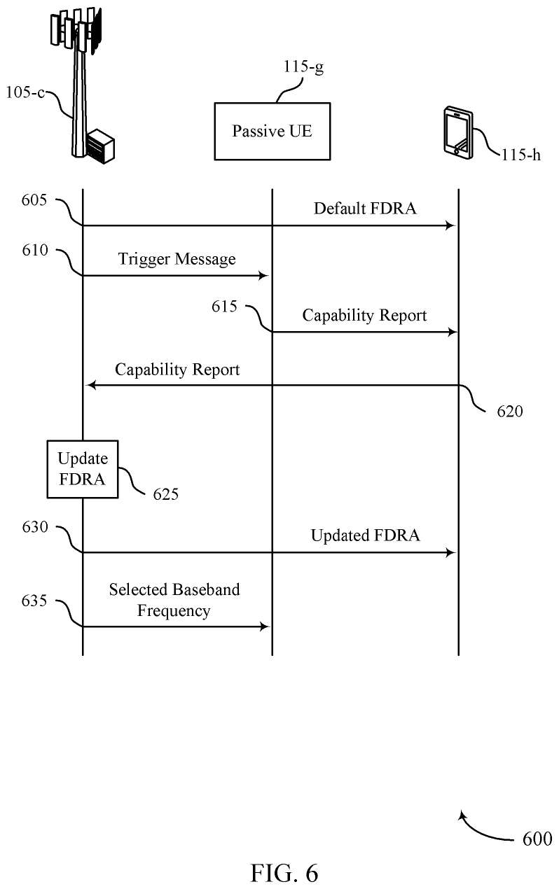

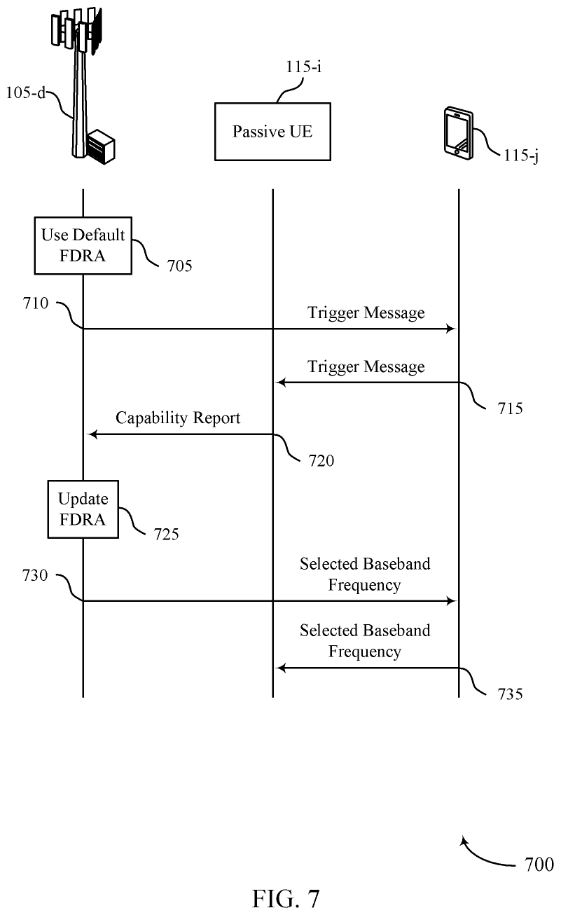

As described herein, a UE 115 (e.g., a passive communication device with backscatter capabilities) may transmit an indication of a baseband frequency shift type (single-side or double-side) supported by the UE 115 for backscatter communications. In some examples, the UE 115 may transmit the indication in response to a query message (as described with reference to FIG. 5) or a trigger message (as described with reference to FIGS. 6 and 7). After transmitting the indication, the UE 115 may receive a control message (from a network entity 105) that indicates an FDRA for backscatter communications at the UE 115. The FDRA may correspond to the baseband frequency shift type supported by the UE 115. Accordingly, the UE 115 may transmit one or more backscatter communications based on the FDRA indicated by the control message. The one or more backscatter communications may be frequency shifted according to the baseband frequency shift type supported by the UE 115.

Aspects of the wireless communications system 100 may be implemented to realize one or more of the following advantages. The techniques described with reference to FIG. 1 may result in greater spectral efficiency and reduced communication resource overhead. More specifically, the described techniques may enable a UE 115 (e.g., a passive UE that supports backscatter communications) to signal support for different frequency shift types and baseband frequencies. A network entity 105 may use this information to select or adjust an FDRA for backscatter communications at the UE 115. Allocating frequency resources according to frequency shift type may improve the spectral efficiency of backscatter communications at the UE 115 by reducing the communication resource overhead of the associated FDRA.

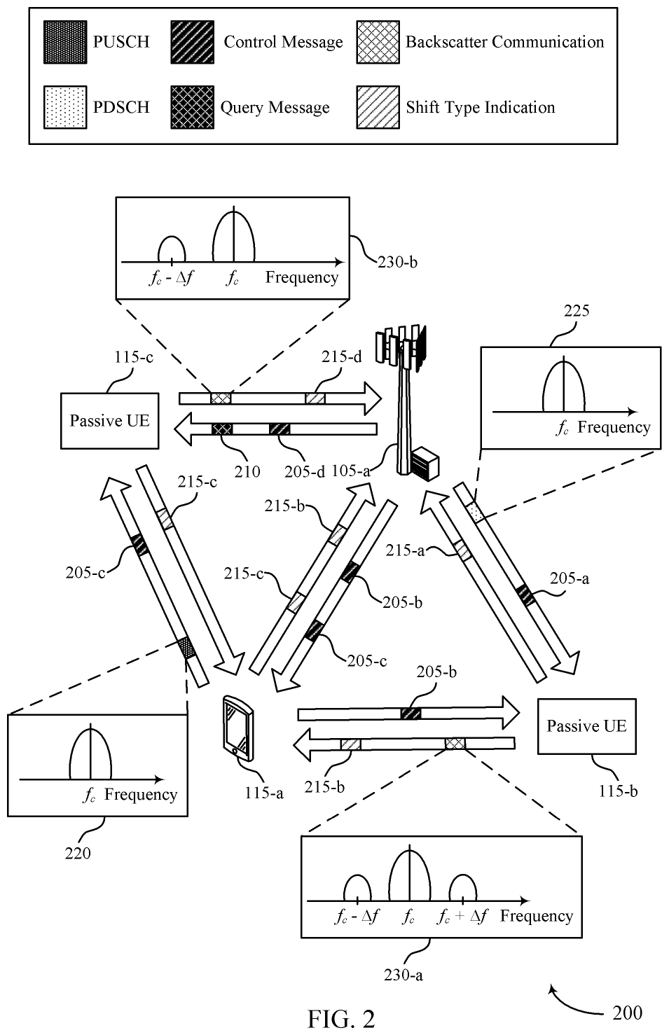

FIG. 2 illustrates an example of a wireless communications system 200 that supports techniques for baseband frequency shifting in accordance with one or more aspects of the present disclosure. The wireless communications system 200 may implement or be implemented by aspects of the wireless communications system 100. For example, the wireless communications system 200 may include a network entity 105-a, a UE 115-a, a UE 115-b (a passive UE configured with a double-side frequency shift type), and a UE 115-c (a passive UE configured with a single-side frequency shift type), which may be examples of corresponding devices described with reference to FIG. 1. In the wireless communications system 200, the UE 115-b and the UE 115-c may indicate support for one or more baseband frequency shift types, which may enable the network entity 105-a to allocate resources with greater spectral efficiency and lower communication resource overhead.

Supporting different baseband frequency shift types for backscatter communications may enable passive UEs to mitigate interference from NR signals. A passive UE with an antenna load switch module can induce a double-side frequency shift (both f_{c}+Δ_{f} and f_{c}−Δ_{f}). A double-side frequency shift may involve fewer hardware constraints and relatively low spectral efficiency. Passive UEs with I/Q modulation capabilities can induce a single-side frequency shift (either f_{c}+Δ_{f} or f_{c}−Δ_{f}). A single-side frequency shift may involve more hardware constraints, and may be associated with relatively high spectral efficiency (in comparison to a double-side frequency shift). A single-side frequency shift can be calculated using the equations sin (f_{c}+Δ_{f})=sin f_{c} cos Δ_{f}+cos f_{c} sin Δ_{f} (for a positive single-side frequency shift) and sin (f_{c}−Δ_{f})=sin f_{c} cos Δ_{f}−cos f_{c} sin Δ_{f} (for a negative single-side frequency shift). Passive UE baseband frequency source types may include a crystal or ring oscillator or a voltage controlled oscillator (VCO). A crystal or ring oscillator may consume less power (>1 μW) and may support fewer frequencies, whereas the VCO may consume more power (>1 mW) and may support a larger frequency range.

The techniques described herein may reduce the communication resource overhead of an FDRA for backscatter communications at a passive UE with single-side or double-side frequency shift capabilities. To effectively support different frequency shift types for backscatter communications, the network entity 105-a may request and obtain frequency shift capability information from different passive UEs. The network entity 105-a may obtain this information via a capability report or via an inventory procedure initiated by the network entity 105-a. The described techniques may result in improved spectral efficiency by enabling the network entity 105-a to use different FDRA schemes for different passive UE frequency shift types. The network entity 105-a may also multiplex signals from passive UEs that support double and single-side frequency shifts (to increase spectral efficiency) or configure passive UEs to perform frequency hopping between a positive single-side frequency shift and a negative single-side frequency shift (to reduce interference and noise).

The wireless communications system 200 may support double-side and single-side frequency shift types for passive UEs with backscatter capabilities. The techniques described with reference to FIG. 2 may include UE-based implementations and network-based implementations. In some UE-based implementations, the network entity 105-a may transmit a backscatter capability reporting trigger message to the UE 115-b (directly or via the UE 115-a). Upon receiving the backscatter capability reporting trigger message, the UE 115-b may transmit a shift type indication 215-a (e.g., a backscattering capability report message) that indicates one or more baseband frequency shift types supported by the UE 115-b. In some examples, the UE 115-b may transmit a shift type indication 215-b (e.g., a backscattering capability report message) to the UE 115-a, and the UE 115-a may relay the shift type indication 215-b to the network entity 105-a.

Before receiving a backscattering capability report message from the UE 115-b, the network entity 105-a may use a default FDRA to receive backscatter communications from the UE 115-b. The default FDRA may, in some examples, correspond to a double-side frequency shift type. A default baseband frequency (which may be an integer number of resource blocks) may be supported by all passive UEs in the wireless communications system 200. The UE 115-b may use this default baseband frequency to transmit the backscattering capability report message. This message may indicate support for a single-side baseband frequency shift type or a double-side baseband frequency shift type. The backscattering capability report message may also indicate baseband frequencies (or corresponding indices) supported by the UE 115-b. The format of the backscattering capability report message may depend on an oscillator type of the UE 115-b. For example, if the UE 115-b is equipped with a crystal or ring oscillator, the UE 115-b may report a frequency set {f₁, f₂, . . . }. Alternatively, if the UE 115-b is equipped with a VCO, the UE 115-b may report start, step and stop frequencies.

In other network-based implementations, the network entity 105-a may transmit a query message 210 to the UE 115-c. The query message 210 may indicate a specific baseband frequency shift type (double-side or single-side). If the baseband frequency shift type specified by the query message 210 corresponds to a baseband frequency shift type supported by the UE 115-c (e.g., a single-side frequency shift type), the UE 115-c may transmit a shift type indication 215-d to the network entity 105-a. Alternatively, the UE 115-c may transmit a shift type indication 215-c to the UE 115-a, and the UE 115-a may relay the shift type indication 215-c to the network entity 105-a. The network entity 105-a may update an FDRA for the UE 115-c based on the shift type indications 215 (query responses) provided by the UE 115-c. Likewise, the network entity 105-a may update an FDRA for the UE 115-b based on the shift type indications 215 (backscattering capability report messages) provided by UE 115-b.

The network entity 105-a may also select a baseband shift frequency for the UE 115-b, and may transmit an indication of the selected baseband frequency to the UE 115-b. The UE 115-b may receive the indication of the selected baseband frequency via a control message 205-a (from the network entity 105-a) or a control message 205-b (from the UE 115-a). Similarly, the network entity 105-a may select a baseband shift frequency for the UE 115-c, and may transmit an indication of the selected baseband frequency to the UE 115-c via a control message 205-c (from the UE 115-a) or a control message 205-d.

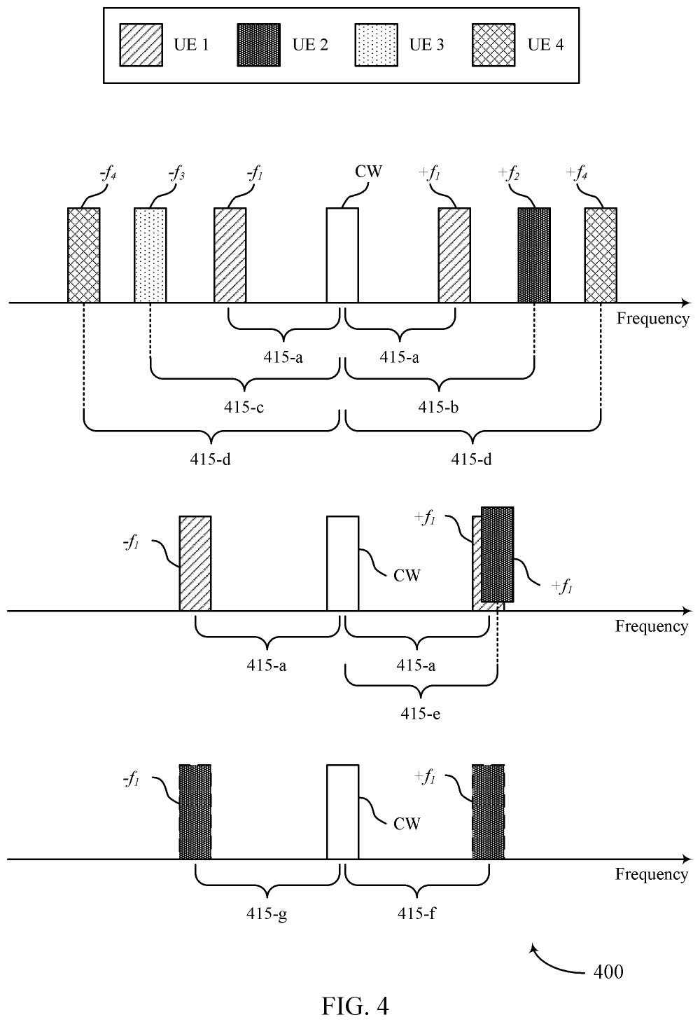

The UE 115-b and the UE 115-c may use the updated FDRAs and the selected baseband frequencies for subsequent backscatter communications with the network entity 105-a and the UE 115-a. For example, the UE 115-c may transmit an uplink-based backscatter communication 230-b to the network entity 105-a by modulating data on a PUSCH transmission 220 from the UE 115-a. As illustrated in the example of FIG. 4, the uplink-based backscatter communication 230-b may be negative single-side frequency shifted (by −Δf) with respect to a carrier frequency (f_{c}) of the PUSCH transmission 220. The UE 115-b may transmit a downlink-based backscatter communication 230-a to the UE 115-a by modulating data on a PDSCH transmission 225 from the network entity 105-a. As shown in the example of FIG. 4, the downlink-based backscatter communication 230-a may be double-side frequency shifted (by ±Δf) with respect to a carrier frequency (f_{c}) of the PDSCH transmission 225.

Aspects of the wireless communications system 200 may be implemented to realize one or more of the following advantages. The techniques described with reference to FIG. 2 may result in greater spectral efficiency and reduced communication resource overhead. More specifically, the described techniques may enable the UE 115-b and the UE 115-c to signal support for different frequency shift types and baseband frequencies. The network entity 105-a may use this information to select or adjust an FDRA for backscatter communications at the UE 115-b or the UE 115-c. Allocating frequency resources according to frequency shift type may improve the spectral efficiency of backscatter communications at the UE 115-b and the UE 115-c by reducing the communication resource overhead of the associated FDRA.

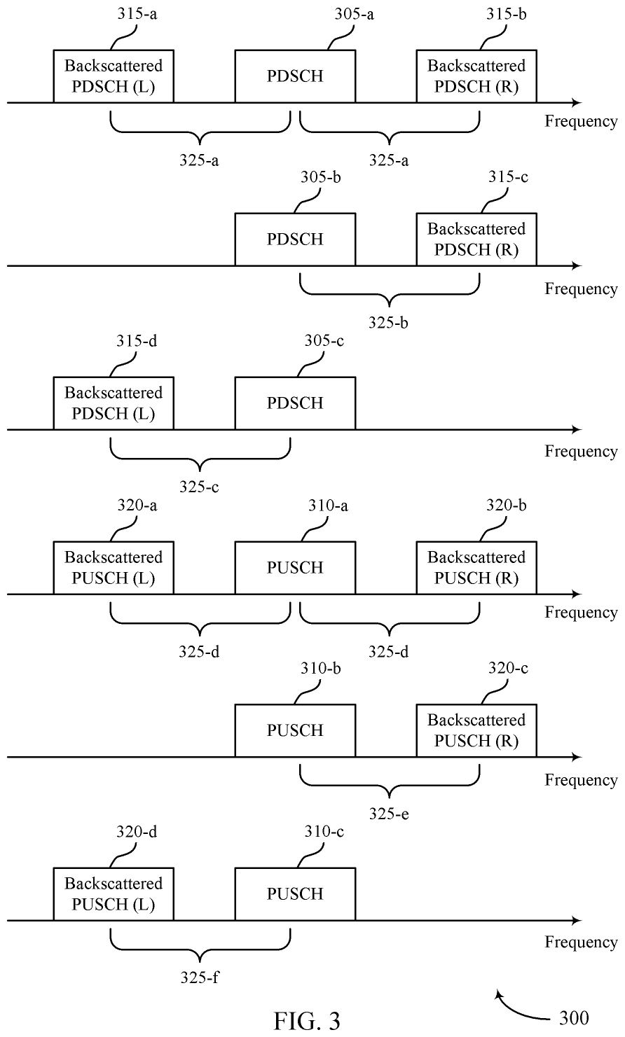

FIG. 3 illustrates an example of a resource diagram 300 that supports techniques for baseband frequency shifting in accordance with one or more aspects of the present disclosure. The resource diagram 300 may implement or be implemented by aspects of the wireless communications system 100 or the wireless communications system 200. For example, the resource diagram 300 may be implemented by a passive UE described with reference to FIGS. 1 and 2. The resource diagram 300 illustrates different baseband frequency shift types (double-side, negative single-side, positive single-side) that a passive UE can use for backscatter communications.

Passive UEs without RF modules may be unable to actively transmit data. However, a passive UE can transmit data by backscattering (e.g., reflecting an incoming signal). When reflecting incoming signals, a passive UE can change a reflection coefficient of the incoming signal, which effectively changes the amplitude or the phase of reflected incoming signal. In some examples, the passive UE may apply a series change to the reflection coefficient (e.g., amplitude * [1, 0.1, 0.1, 1, . . . ]). As a result, the backscattered signal may be the incoming signal with an amplitude change (which is used to convey data from the passive UE). If the series change to the reflection coefficient is amplitude *[1, 0.1, 0.1, 1, . . . ], the backscattered signal may be equal to the product of the incoming signal and a square wave with an amplitude of (1, 0.1, 1, 0.1, . . . ), which results in a frequency shift with respect to the incoming signal. The square wave is generated by the passive UE switching between antenna load impedances. However, using antenna load switching techniques to generate square waves may result in a double-side frequency shift where the left side (f_{c}−Δf) and the right side (f_{c}+Δf) of the carrier frequency carry the same data. Antenna load switching is used in various RFID applications.

Some passive UEs may be capable of using a single-side frequency shift where one side (e.g., f_{c}−Δf or f_{c}+Δf) of the carrier frequency carries data from the passive UE. This backscattering technique involves adding circuit modules to the antenna load impedance switching module used for double-side frequency shifts. When using a single-side frequency shift, data from a passive UE can be carried (indicated, signaled) by changing an amplitude or phase of the square wave. For example, to transmit a bit value of 0, a backscattered signal may be equal to the product of the incoming signal and a square wave with an amplitude of (1, 0, 1, 0, . . . ). To transmit a bit value of 1, the backscattered signal may be equal to the product of the incoming signal and a square wave with an amplitude of (0.5, 0, 0.5, 0, . . . ) or (0, 1, 0, 1, . . . ).

In the example of FIG. 3, a passive UE may use a PDSCH signal 305-a from a network entity to power up, and may modulate data on the PDSCH signal 305-a using backscatter techniques. More specifically, the passive UE may apply a double-side frequency shift 325-a to the PDSCH signal 305-a, which may result in a backscattered PDSCH signal 315-a and a backscattered PDSCH signal 315-b. In a similar manner, the passive UE may apply a positive single-side frequency shift 325-b to a PDSCH signal 305-b, which may result in a backscattered PDSCH signal 315-c. Likewise, the passive UE may apply a negative single-side frequency shift 325-c to a PDSCH signal 305-c, which may result in a backscattered PDSCH signal 315-d. In comparison to the PDSCH signals 305, the backscattered PDSCH signals 315 may have different amplitudes or phases. In other words, the passive UE may backscatter data on the PDSCH signals 305 by changing one or more of an amplitude, frequency, or phase of the PDSCH signals 305. As such, the backscattered PDSCH signals 315 may include PDSCH data (from the network entity) and data from the passive UE.

Additionally or alternatively, the passive UE may use a PUSCH signal 310-a from a network entity to power up, and may modulate data on the PUSCH signal 310-a using backscatter techniques. More specifically, the passive UE may apply a double-side frequency shift 325-d to the PUSCH signal 310-a, which may result in a backscattered PUSCH signal 320-a and a backscattered PUSCH signal 320-b. In a similar manner, the passive UE may apply a positive single-side frequency shift 325-e to a PUSCH signal 310-b, which may result in a backscattered PUSCH signal 320-c. Likewise, the passive UE may apply a negative single-side frequency shift 325-f to a PUSCH signal 310-c, which may result in a backscattered PUSCH signal 320-d. In comparison to the PUSCH signals 310, the backscattered PUSCH signals 320 may have different amplitudes or phases. In other words, the passive UE may backscatter data on the PUSCH signals 310 by changing one or more of an amplitude, frequency, or phase of the PUSCH signals 310. As such, the backscattered PUSCH signals 320 may include PUSCH data (from the network entity) and data from the passive UE.

As described herein, aspects of the resource diagram 300 may support different frequency shift types for passive UEs with backscatter capabilities. Configuring passive UEs to indicate support for different frequency shift types may enable a network entity to allocate frequency resources (to the passive UEs) with greater efficiency. In contrast to NR UEs, passive UEs without RF modules may be unable to generate high baseband frequencies. Also, passive UEs with different hardware configurations or power capabilities may generate different baseband frequencies. Supporting different frequency shift types for backscatter communications may reduce interference between backscatter communications and NR communications. Ambient NR signals may have a higher transmit power in comparison to backscattered signals. As such, applying a frequency shift to backscatter communications may reduce the likelihood of interference from ambient NR signals.

Supporting different frequency shift types for backscatter communications may also result in greater spectral efficiency. For example, a network entity may allocate single-side frequency resources for passive UEs with I/Q modulation hardware configurations. The network entity may also multiplex backscatter communications from UEs that support different baseband frequency shift types. Additionally, configuring passive UEs to hop between positive and negative single-side frequency shifts (as described with reference to FIG. 4) may further reduce interference between NR communications and backscatter communications. The techniques described herein may support reporting and inventory procedures for both downlink-based and uplink-based passive IoT systems.

FIG. 4 illustrates an example of a resource diagram 400 that supports techniques for baseband frequency shifting in accordance with one or more aspects of the present disclosure. The resource diagram 400 may implement or be implemented by aspects of the wireless communications system 100 or the wireless communications system 200. For example, the resource diagram 400 may be implemented by a UE 115 (e.g., a passive UE with backscatter capabilities) or a network entity 105, as described with reference to FIGS. 1 and 2. The resource diagram 400 illustrates different FDRAs, multiplexing procedures, and frequency hopping schemes that can be used for backscatter communications at a passive UE.

The techniques described with reference to FIG. 4 may support downlink control information (DCI) enhancements that enable an NR UE (e.g., a UE that supports NR communications) to receive backscatter communications from a passive UE with double-side or single-side baseband frequency shifting capabilities. For example, the NR UE may receive DCI that indicates baseband frequency shift information for one or more passive UEs in a wireless communications system. The baseband frequency shift information may be indicated per baseband shift frequency or per baseband frequency shift type. If the baseband frequency shift information is indicated per baseband shift frequency, a first bit (0 or 1) may indicate whether a given baseband frequency corresponds to a single-side frequency shift or a double-side frequency shift for each passive UE. If a baseband frequency corresponds to a single-side frequency shift, a second bit (0 or 1) may indicate whether the single-side frequency shift is positive or negative. Thus, a first shift flag (01) may indicate a double-side frequency shift type, a second shift flag (10) may indicate a positive double-side frequency shift type, a third shift flag (11) may indicate a negative double-side frequency shift type, and a fourth shift flag (00) may indicate that no passive UEs are available at a given baseband shift frequency.

A network entity may use an enhanced DCI format to signal baseband frequency shift information (per baseband shift frequency) for multiple passive UEs. This DCI format may include a shift flag and frequency shift index for each passive UE. For example, the DCI format may include a first shift flag (01) and frequency shift index (00) for a first passive UE (UE 1), a second shift flag (10) and frequency shift index (01) for a second passive UE (UE 2), a third shift flag (11) and frequency shift index (11) for a third passive UE (UE 3), and a fourth shift flag (01) and frequency shift index (10) for a fourth passive UE (UE 4). The first shift flag and frequency shift index may indicate a double-side frequency shift 415-a for a first baseband shift frequency (±f₁), while the second shift flag and frequency shift index may indicate a positive single-side frequency shift 415-b for a second baseband shift frequency (+f₂). Similarly, the third shift flag and frequency shift index may indicate a negative single-side frequency shift 415-c for a third baseband shift frequency (−f₃), and the fourth shift flag and frequency shift index may indicate a double-side frequency shift 415-d for a fourth baseband shift frequency (±f₄). The baseband shift frequencies may be indicated relative to a CW such as an NR downlink signal or an NR uplink signal.

If the baseband frequency shift information is indicated per baseband frequency shift type, the network entity may indicate double-side, positive single-side, and negative single-side frequency shifts in respective groups. For example, the network entity may indicate (using an enhanced DCI format) shift frequencies associated with a double-side frequency shift type in a first group, shift frequencies associated with a positive single-side frequency shift type in a second group, and shift frequencies associated with a negative single-side frequency shift type in a third group. In the example of FIG. 4, the first group may include the first frequency shift index (00) corresponding the first baseband shift frequency (f₁) and the fourth frequency shift index (10) corresponding to the fourth baseband shift frequency (f₄) because these baseband shift frequencies are associated with a double-side frequency shift type. The second group may include the second frequency shift index (01) corresponding to the second baseband shift frequency (f₂), as this frequency is associated with a positive single-side frequency shift type. The third group may include the third frequency shift index (11) corresponding to the third baseband shift frequency (f₃) because the third baseband shift frequency is associated with a negative single-side frequency shift type.

Aspects of the resource diagram 400 may also support multiplexing double-side frequency shifted backscatter communications with single-side frequency shifted backscatter communications. For example, if a first passive UE (UE 1) supports a double-side frequency shift type and a second passive UE (UE 2) supports a single-side frequency shift type, a network entity may configure both passive UEs to backscatter at the same time using the same frequency shift value (magnitude). Accordingly, the first UE may transmit backscatter communications using a double-side frequency shift 415-a (±f₁), and the second passive UE may perform backscatter communications using a single-side frequency shift 415-e (+f₁) at approximately the same time. At the shift frequency +f₁, signals from the first passive UE and the second passive UE may overlap in time and frequency. To decode the overlapping backscatter communications from the first passive UE and the second passive UE, the network entity may first decode backscatter communications from the first passive UE that are non-overlapping with the backscatter communications from the second passive UE (e.g., signals at the frequency −f₁). After decoding the non-overlapping portion of the backscatter communications, the network entity may subtract the decoded signal from the overlapping backscatter communications at the frequency+f₁.

Some passive UEs may use positive and negative single-side frequency shift hopping for backscatter communications. For example, the second passive UE (UE 2) may randomly hop (switch, alternate) between a positive single-side frequency shift 415-f (+f₁) and a negative single-side frequency shift 415-g (−f₁) to randomize interference and noise. Additionally or alternatively, the second UE may transmit an additional bit sequence by hopping between the positive single-side frequency shift 415-f (+f₁) and the negative single-side frequency shift 415-g (−f₁). This bit sequence can be data or control information like an identifier of the second UE. As an example, the second UE may transmit a first bit value (0) with a frequency shift of +f₁, and may transmit a second bit value (1) with a frequency shift of −f₁.

The network entity may decode the bit sequence by detecting the power or strength of signals at +f₁ and −f₁, respectively. For example, the network entity may detect the first bit value (0) if a received power of signals at +f₁ is larger than a received power of signals at −f₁. Otherwise, the network entity may detect the second bit value (1). In some examples, the network entity may control the frequency shift hopping behavior of a passive UE via an FDRA or a trigger message that configures the passive UE to use random frequency hopping or index modulation (e.g., bit sequence transmission with baseband frequency shift hopping) for backscatter communications.

Aspects of the resource diagram 400 may be implemented to realize one or more of the following advantages. The techniques described with reference to FIG. 4 may result in greater spectral efficiency and reduced communication resource overhead. More specifically, the described techniques may enable a passive UE to signal support for different frequency shift types and baseband frequencies. A network entity may use this information to select or adjust an FDRA for backscatter communications at the passive UE. Allocating frequency resources according to frequency shift type may improve the spectral efficiency of backscatter communications at the passive UE by reducing the communication resource overhead of the associated FDRA.

FIG. 5 illustrates an example of a process flow 500 that supports techniques for baseband frequency shifting in accordance with one or more aspects of the present disclosure. The process flow 500 may implement or be implemented by aspects of the wireless communications system 100 or the wireless communications system 200. For example, the process flow 500 may include a network entity 105-b, a UE 115-d, a UE 115-e, and a UE 115-f, which may be examples of corresponding devices described with reference to FIGS. 1 and 2. In the following description of the process flow 500, operations between the network entity 105-b and the UEs 115 may be performed in a different order or at different times. Some operations may also be omitted from the process flow 500, and other operations may be added to the process flow 500.

As described with reference to FIGS. 1 through 4, some passive devices may be capable of using different frequency shift types for backscatter communications. For example, some passive devices may support one or more of a double-side frequency shift type or a single-side frequency shift type. Backscattered signals that are single-side frequency shifted may span fewer frequency resources in comparison to backscattered signals that are double-side frequency shifted. As such, the number of frequency resources used for backscatter communications may depend on the frequency shift type used to transmit the backscatter communications. However, the network may be unable to consider the frequency shift type of a passive device when allocating resources to the passive device.

Aspects of the present disclosure support techniques for reporting or otherwise signaling support for different frequency shift types. In some implementations, a passive communication device may transmit a capability report that indicates one or more frequency shift types supported by the passive communication device. The capability report may also indicate a number of baseband frequencies that the passive communication device is capable of using for backscatter communications. In some examples, the passive communication device may backscatter the capability report on another signal. After receiving the capability report, the network may select or update an FDRA for the passive communication device, and may indicate this information to the passive communication device via control signaling (e.g., DCI). Accordingly, the passive communication device may use the indicated FDRA for subsequent backscatter communications.

The process flow 500 may illustrate an example of a network-based query procedure between the UE 115-d (a passive UE that supports a first baseband frequency shift type), the UE 115-e (a passive UE that supports a second baseband frequency shift type), the UE 115-f (a UE that supports NR communications), and the network entity 105-b. At 505, the network entity 105-b may transmit a query message to the UE 115-d. The network entity 105-b may also transmit the query message to the UE 115-e at 510. The query message (also referred to as an inventory query message) may indicate a specific baseband frequency shift type. For example, the query message may indicate a double-side baseband frequency shift type or a single-side baseband frequency shift type. If, for example, the UE 115-d supports the baseband frequency shift type specified by the query message, the UE 115-d may respond to the query message at 515. In contrast, if the UE 115-e supports a different baseband frequency shift type, the UE 115-e may refrain from responding to the query message from the network entity 105-b.

The UE 115-d may transmit a response to the UE 115-f if the baseband frequency shift type specified by the query message corresponds to a baseband frequency shift type of the UE 115-d. At 525, the UE 115-f may relay the response from the UE 115-d to the network entity 105-b. At 530, the network entity 105-b may determine that the UE 115-d supports the baseband frequency shift type indicated by the query message. In some examples, the network entity 105-b may determine the baseband frequency shift type of the UE 115-e by transmitting another query message associated with a different baseband frequency shift type. The network entity 105-b may use this information to update respective FDRAs for the UE 115-d and the UE 115-e.

Aspects of the process flow 500 may be implemented to realize one or more of the following advantages. The techniques described with reference to FIG. 5 may result in greater spectral efficiency and reduced communication resource overhead. More specifically, the described techniques may enable the UE 115-e to signal support for different frequency shift types and baseband frequencies. The network entity 105-b may use this information to select or adjust an FDRA for backscatter communications at the UE 115-e. Allocating frequency resources according to frequency shift type may improve the spectral efficiency of backscatter communications at the UE 115-e by reducing the communication resource overhead of the associated FDRA.

FIG. 6 illustrates an example of a process flow 600 that supports techniques for baseband frequency shifting in accordance with one or more aspects of the present disclosure. The process flow 600 may implement or be implemented by aspects of the wireless communications system 100 or the wireless communications system 200. For example, the process flow 600 may include a network entity 105-c, a UE 115-g, and a UE 115-h, which may be examples of corresponding devices described with reference to FIGS. 1 and 2. In the following description of the process flow 600, operations between the network entity 105-c and the UEs 115 may be performed in a different order or at different times. Some operations may also be omitted from the process flow 600, and other operations may be added to the process flow 600.

As described with reference to FIGS. 1 through 5, the UE 115-g may transmit an indication of a baseband frequency shift type (single-side or double-side) supported by the UE 115-g for backscatter communications. The UE 115-g may receive a control message (e.g., DCI) that indicates an FDRA for backscatter communications at the UE 115-g. The FDRA may correspond to the baseband frequency shift type supported by the UE 115-g. Accordingly, the UE 115-g may transmit one or more backscatter communications based on the FDRA indicated by the control message. The one or more backscatter communications (which may include uplink-based or downlink-based backscatter transmissions) may be frequency shifted according to the baseband frequency shift type supported by the UE 115-g.

The process flow 600 may illustrate an example of a downlink-based passive UE report signaling procedure between the network entity 105-c, the UE 115-g (e.g., a passive UE that supports backscatter communications), and the UE 115-h (e.g., a UE that supports NR communications). The network entity 105-c may initially use a default FDRA to receive backscatter transmissions from the UE 115-g. This default FDRA may be centered at an NR downlink frequency with a default frequency shift. At 605, the network entity 105-c may transmit (via DCI) an indication of the default FDRA to the UE 115-h such that the UE 115-h can use the default FDRA to receive backscatter communications from the UE 115-g. The UE 115-g may perform downlink-based backscatter communications (based on the default FDRA) by applying a default baseband frequency shift to a PDSCH transmission from the network entity 105-c, as described with reference to FIG. 3.

At 610, the network entity 105-c may transmit a backscattering capability report trigger message to the UE 115-g. At 615, the UE 115-g may transmit a backscattering capability report message to the UE 115-h in response to the backscattering capability report trigger message from the network entity 105-c. The UE 115-g may transmit the backscattering capability report message using a default baseband frequency. The backscattering capability report message may indicate one or more of a baseband frequency shift type supported by the UE 115-g (double-side or single-side), a set of baseband frequencies supported by the UE 115-g, or an identifier of the UE 115-g. At 620, the UE 115-h may relay the backscattering capability report message to the network entity 105-c.

At 625, the network entity 105-c may update the FDRA for the UE 115-g based on the backscattering capability report message from the UE 115-g. If, for example, the UE 115-g indicates support for a double-side frequency shift type, the network entity 105-c may update the FDRA for the UE 115-g accordingly. In other examples, if the UE 115-g indicates support for a single-side frequency shift type, the network entity 105-c may update the FDRA for the UE 115-g accordingly. At 630, the network entity 105-c may transmit (via DCI) an indication of the updated FDRA to the UE 115-h such that the UE 115-h can use the updated FDRA to receive backscatter communications from the UE 115-g. The network entity 105-c may also select a baseband frequency for backscatter communications at the UE 115-g. At 635, the network entity 105-c may transmit an indication of the selected baseband frequency to the UE 115-g. The UE 115-g may use the indicated frequency shift type (from the backscattering capability report message) and the selected baseband frequency (signaled by the network entity 105-c) for subsequent backscatter communications.

Aspects of the process flow 600 may be implemented to realize one or more of the following advantages. The techniques described with reference to FIG. 6 may result in greater spectral efficiency and reduced communication resource overhead. More specifically, the described techniques may enable the UE 115-g to signal support for different frequency shift types and baseband frequencies. The network entity 105-c may use this information to select or adjust an FDRA for backscatter communications at the UE 115-g. Allocating frequency resources according to frequency shift type may improve the spectral efficiency of backscatter communications at the UE 115-g by reducing the communication resource overhead of the associated FDRA.

FIG. 7 illustrates an example of a process flow 700 that supports techniques for baseband frequency shifting in accordance with one or more aspects of the present disclosure. The process flow 700 may implement or be implemented by aspects of the wireless communications system 100 or the wireless communications system 200. For example, the process flow 700 may include a network entity 105-d, a UE 115-i, and a UE 115-j, which may be examples of corresponding devices described with reference to FIGS. 1 and 2. In the following description of the process flow 700, operations between the network entity 105-d and the UEs 115 may be performed in a different order or at different times. Some operations may also be omitted from the process flow 700, and other operations may be added to the process flow 700.

As described with reference to FIGS. 1 through 6, the UE 115-i (e.g., a passive UE with backscatter capabilities) may transmit an indication of a baseband frequency shift type (single-side or double-side) supported by the UE 115-i for backscatter communications. The UE 115-i may receive a control message (e.g., DCI) that indicates an FDRA for backscatter communications at the UE 115-i. The FDRA may correspond to the baseband frequency shift type supported by the UE 115-i. Accordingly, the UE 115-i may transmit one or more backscatter communications based on the FDRA indicated by the control message. The one or more backscatter communications (which may include uplink-based or downlink-based backscatter transmissions) may be frequency shifted according to the baseband frequency shift type supported by the UE 115-i.

The process flow 700 may illustrate an example of an uplink-based passive UE report signaling procedure between the network entity 105-d, the UE 115-i (e.g., a passive UE that supports backscatter communications), and the UE 115-j (e.g., a UE that supports NR communications). At 705, the network entity 105-d use a default FDRA to receive backscatter transmissions from the UE 115-i. The default FDRA may be centered at an NR uplink frequency with a default frequency shift. The UE 115-i may perform uplink-based backscatter communications (based on the default FDRA) by applying a default baseband frequency shift to a PUSCH transmission from the UE 115-j, as described with reference to FIG. 3.

At 710, the network entity 105-d may transmit a backscattering capability report trigger message to the UE 115-j. At 715, the UE 115-j may relay the backscattering capability report trigger message to the UE 115-i. At 720, the UE 115-i may transmit a backscattering capability report message to the network entity 105-d using a default baseband frequency. The backscattering capability report message may indicate one or more of a baseband frequency shift type supported by the UE 115-i (double-side or single-side), a set of baseband frequencies supported by the UE 115-i, or an identifier of the UE 115-i.

At 725, the network entity 105-d may update the FDRA for the UE 115-i based on the backscattering capability report message from the UE 115-i. If, for example, the UE 115-i indicates support for a double-side frequency shift type, the network entity 105-d may update the FDRA for the UE 115-i accordingly. In other examples, if the UE 115-i indicates support for a single-side frequency shift type, the network entity 105-d may update the FDRA for the UE 115-i accordingly. The network entity 105-d may also select a baseband frequency for backscatter communications at the UE 115-i. At 730, the network entity 105-d may transmit an indication of the selected baseband frequency to the UE 115-j. At 735, the UE 115-j may relay this indication to the UE 115-i. The UE 115-i may use the indicated frequency shift type (from the backscattering capability report message) and the selected baseband frequency (signaled by the network entity 105-d) for subsequent backscatter communications.

Aspects of the process flow 700 may be implemented to realize one or more of the following advantages. The techniques described with reference to FIG. 7 may result in greater spectral efficiency and reduced communication resource overhead. More specifically, the described techniques may enable the UE 115-i to signal support for different frequency shift types and baseband frequencies. The network entity 105-d may use this information to select or adjust an FDRA for backscatter communications at the UE 115-i. Allocating frequency resources according to frequency shift type may improve the spectral efficiency of backscatter communications at the UE 115-i by reducing the communication resource overhead of the associated FDRA.

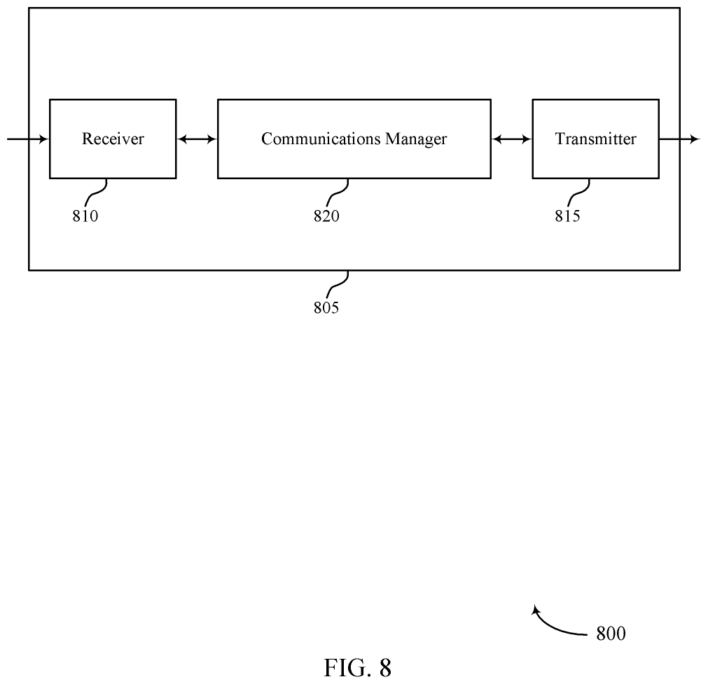

FIG. 8 shows a block diagram 800 of a device 805 that supports techniques for baseband frequency shifting in accordance with one or more aspects of the present disclosure. The device 805 may be an example of aspects of a UE 115, as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for baseband frequency shifting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for baseband frequency shifting). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for baseband frequency shifting, as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware, software (e.g., executed by a processor), or any combination thereof. The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled (e.g., operatively, communicatively, functionally, electronically, or electrically) with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in hardware, software (e.g., executed by a processor), or any combination thereof. If implemented in code executed by a processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations, as described herein.

The communications manager 820 may support wireless communication at the device 805 in accordance with examples disclosed herein. For example, the communications manager 820 may be configured as or otherwise support a means for outputting (to the transmitter 815) an indication of a baseband frequency shift type supported by the UE for backscatter communications, where the baseband frequency shift type includes one or both of a single-side frequency shift or a double-side frequency shift. The communications manager 820 may be configured as or otherwise support a means for obtaining (from the receiver 810) a control message that indicates an FDRA for backscatter communications at the device 805, where the FDRA corresponds to the baseband frequency shift type supported by the device 805. The communications manager 820 may be configured as or otherwise support a means for outputting (to the transmitter 815) one or more backscatter communications based on the FDRA indicated by the control message, where the one or more backscatter communications are frequency shifted according to the baseband frequency shift type supported by the device 805.

By including or configuring the communications manager 820 in accordance with examples, as described herein, the device 805 (e.g., a processor controlling or otherwise coupled (e.g., operatively, communicatively, functionally, electronically, or electrically) with the receiver 810, the transmitter 815, the communications manager 820, or a combination thereof) may support techniques for more efficient utilization of communication resources by reducing the communication resource overhead associated with an FDRA for backscatter communications at the device 805.

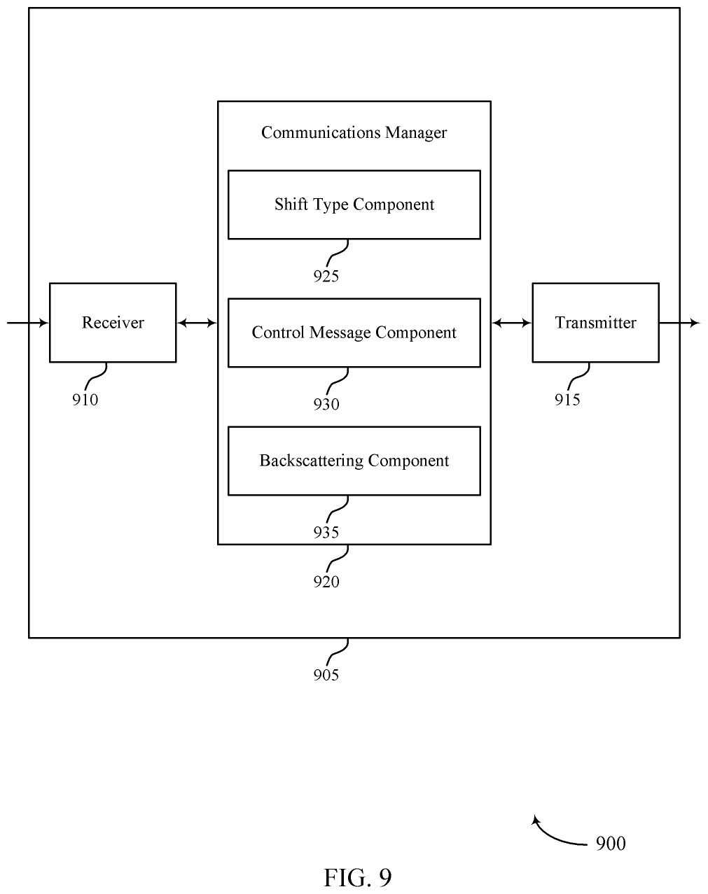

FIG. 9 shows a block diagram 900 of a device 905 that supports techniques for baseband frequency shifting in accordance with one or more aspects of the present disclosure. The device 905 may be an example of aspects of a device 805 or a UE 115, as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for baseband frequency shifting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for baseband frequency shifting). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for baseband frequency shifting, as described herein. For example, the communications manager 920 may include a shift type component 925, a control message component 930, a backscattering component 935, or any combination thereof. The communications manager 920 may be an example of aspects of a communications manager 820, as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations, as described herein.

The communications manager 920 may support wireless communication at the device 905 in accordance with examples disclosed herein. The shift type component 925 may be configured as or otherwise support a means for outputting (to the transmitter 915) an indication of a baseband frequency shift type supported by the device 905 for backscatter communications, where the baseband frequency shift type includes one or both of a single-side frequency shift or a double-side frequency shift. The control message component 930 may be configured as or otherwise support a means for obtaining (from the receiver 910) a control message that indicates an FDRA for backscatter communications at the device 905, where the FDRA corresponds to the baseband frequency shift type supported by the device 905. The backscattering component 935 may be configured as or otherwise support a means for outputting (to the transmitter 915) one or more backscatter communications based on the FDRA indicated by the control message, where the one or more backscatter communications are frequency shifted according to the baseband frequency shift type supported by the device 905.

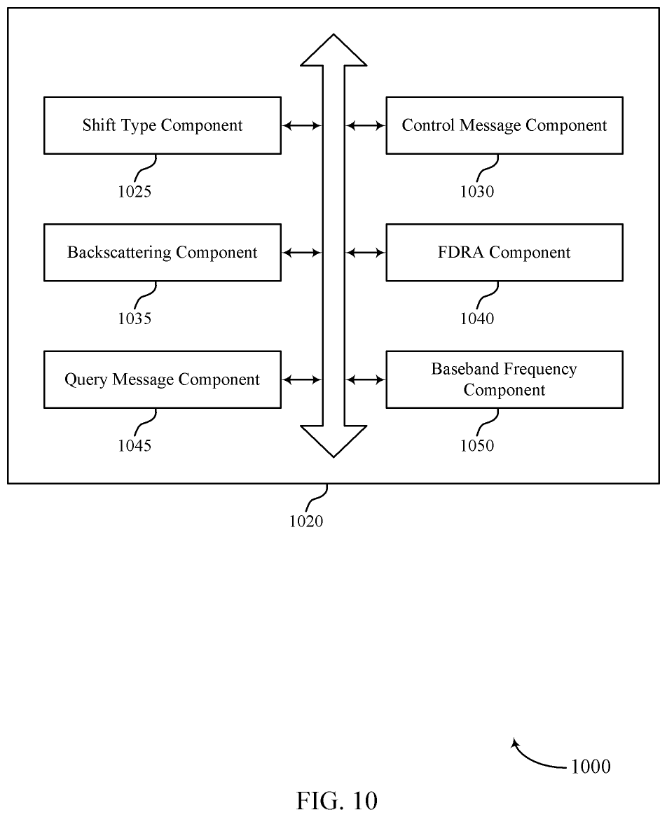

FIG. 10 shows a block diagram 1000 of a communications manager 1020 that supports techniques for baseband frequency shifting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of the techniques described herein. For example, the communications manager 1020 may include a shift type component 1025, a control message component 1030, a backscattering component 1035, an FDRA component 1040, a query message component 1045, a baseband frequency component 1050, or any combination thereof. Each of these components may communicate, directly or indirectly, with one another (e.g., via one or more buses).

The communications manager 1020 may support wireless communication at a UE in accordance with examples disclosed herein. The shift type component 1025 may be configured as or otherwise support a means for transmitting an indication of a baseband frequency shift type supported by the UE for backscatter communications, where the baseband frequency shift type includes one or both of a single-side frequency shift or a double-side frequency shift. The control message component 1030 may be configured as or otherwise support a means for receiving a control message that indicates an FDRA for backscatter communications at the UE, where the FDRA corresponds to the baseband frequency shift type supported by the UE. The backscattering component 1035 may be configured as or otherwise support a means for transmitting one or more backscatter communications based on the FDRA indicated by the control message, where the one or more backscatter communications are frequency shifted according to the baseband frequency shift type supported by the UE.

In some examples, to support transmitting the indication of the baseband frequency shift type supported by the UE, the shift type component 1025 may be configured as or otherwise support a means for transmitting a report that indicates a set of baseband frequencies supported by the UE in connection with the baseband frequency shift type supported by the UE.

In some examples, the baseband frequency component 1050 may be configured as or otherwise support a means for receiving an indication of a selected baseband frequency from the set of baseband frequencies indicated by the report, where the one or more backscatter communications are frequency shifted according to the selected baseband frequency.

In some examples, the backscattering component 1035 may be configured as or otherwise support a means for transmitting at least one backscatter communication based on a default FDRA prior to transmitting the report, where the at least one backscatter communication is frequency shifted according to the baseband frequency shift type supported by the UE.

In some examples, the FDRA component 1040 may be configured as or otherwise support a means for receiving DCI that indicates an updated FDRA for backscatter communications at the UE, where the updated FDRA is based on the report.

In some examples, the report indicates start frequencies associated with the set of baseband frequencies, step frequencies associated with the set of baseband frequencies, stop frequencies associated with the set of baseband frequencies, each frequency in the set of baseband frequencies, or a combination thereof.

In some examples, the report is transmitted via a default baseband frequency. In some examples, the set of baseband frequencies indicated by the report is associated with a baseband frequency source type of the UE.

In some examples, the FDRA component 1040 may be configured as or otherwise support a means for receiving DCI that indicates a default FDRA for backscatter communications at the UE.

In some examples, the query message component 1045 may be configured as or otherwise support a means for receiving a query message associated with a double-side frequency shift type or a single-side frequency shift type, where transmitting the indication of the baseband frequency shift type supported by the UE is based on the query message.

In some examples, to support receiving the control message, the control message component 1030 may be configured as or otherwise support a means for receiving an indication of frequency shift information for different frequency shift values or different frequency shift types supported by other UEs, where the frequency shift information indicates one or more of a frequency, a frequency index, a frequency shift type, an index associated with a frequency shift type, or a sign of the frequency shift type used for backscatter communications at the other UEs.

In some examples, to support transmitting the one or more backscatter communications, the backscattering component 1035 may be configured as or otherwise support a means for transmitting, in accordance with a frequency shift hopping scheme, a first backscatter communication that is frequency shifted according to a negative single-side frequency shift and a second backscatter communication that is frequency shifted according to a positive single-side frequency shift.

In some examples, to support transmitting the one or more backscatter communications, the backscattering component 1035 may be configured as or otherwise support a means for transmitting a first portion of a bit sequence that is frequency shifted according to a negative single-side frequency shift. In some examples, to support transmitting the one or more backscatter communications, the backscattering component 1035 may be configured as or otherwise support a means for transmitting a second portion of the bit sequence that is frequency shifted according to a positive single-side frequency shift, where the bit sequence includes data or control information. In some examples, the FDRA indicates a frequency hopping scheme for backscatter communications at the UE.

In some examples, to support transmitting the one or more backscatter communications, the backscattering component 1035 may be configured as or otherwise support a means for receiving a downlink shared channel transmission via a downlink baseband frequency. In some examples, to support transmitting the one or more backscatter communications, the backscattering component 1035 may be configured as or otherwise support a means for signaling the one or more backscatter communications by frequency shifting the downlink shared channel transmission with respect to the downlink baseband frequency and modifying one or both of an amplitude or a phase of the downlink shared channel transmission.

In some examples, to support transmitting the one or more backscatter communications, the backscattering component 1035 may be configured as or otherwise support a means for receiving an uplink shared channel transmission via an uplink baseband frequency. In some examples, to support transmitting the one or more backscatter communications, the backscattering component 1035 may be configured as or otherwise support a means for signaling the one or more backscatter communications by frequency shifting the uplink shared channel transmission with respect to the uplink baseband frequency and modifying one or both of an amplitude or a phase of the uplink shared channel transmission. In some examples, the indication of the baseband frequency shift type is transmitted in response to a trigger message.

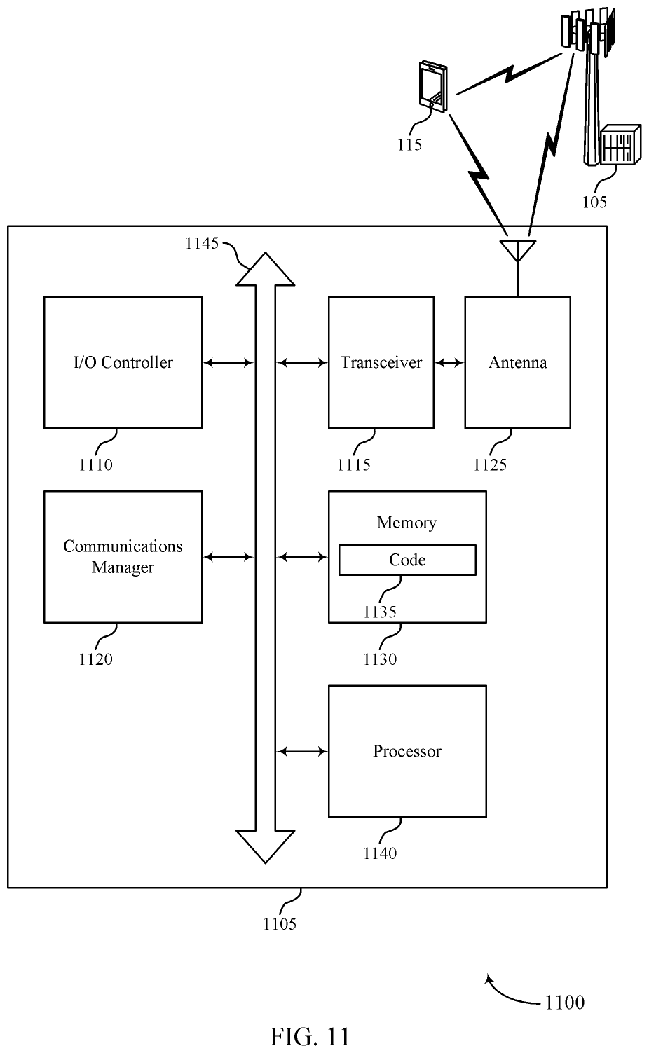

FIG. 11 shows a diagram of a system 1100 including a device 1105 that supports techniques for baseband frequency shifting in accordance with one or more aspects of the present disclosure. The device 1105 may be an example of or include the components of a device 805, a device 905, or a UE 115, as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOSR, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links, as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for baseband frequency shifting). For example, the device 1105 or a component of the device 1105 may include a processor 1140 and memory 1130 coupled (e.g., operatively, communicatively, functionally, electronically, or electrically) with or to the processor 1140, the processor 1140 and memory 1130 configured to perform various functions described herein.

The communications manager 1120 may support wireless communication at the device 1105 in accordance with examples disclosed herein. For example, the communications manager 1120 may be configured as or otherwise support a means for outputting (to the transceiver 1115) an indication of a baseband frequency shift type supported by the device 1105 for backscatter communications, where the baseband frequency shift type includes one or both of a single-side frequency shift or a double-side frequency shift. The communications manager 1120 may be configured as or otherwise support a means for obtaining (from the transceiver 1115) a control message that indicates an FDRA for backscatter communications at the device 1105, where the FDRA corresponds to the baseband frequency shift type supported by the device 1105. The communications manager 1120 may be configured as or otherwise support a means for outputting (to the transceiver 1115) one or more backscatter communications based on the FDRA indicated by the control message, where the one or more backscatter communications are frequency shifted according to the baseband frequency shift type supported by the device 1105.

By including or configuring the communications manager 1120 in accordance with examples, as described herein, the device 1105 may support techniques for greater spectral efficiency and reduced communication resource overhead. More specifically, the described techniques may enable the device 1105 to signal support for different frequency shift types and baseband frequencies. A network entity may use this information to select or adjust an FDRA for backscatter communications at the device 1105. Allocating frequency resources according to frequency shift type may improve the spectral efficiency of backscatter communications at the device 1105 by reducing the communication resource overhead of the associated FDRA.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for baseband frequency shifting, as described herein, or the processor 1140 and the memory 1130 may be otherwise configured to perform or support such operations.

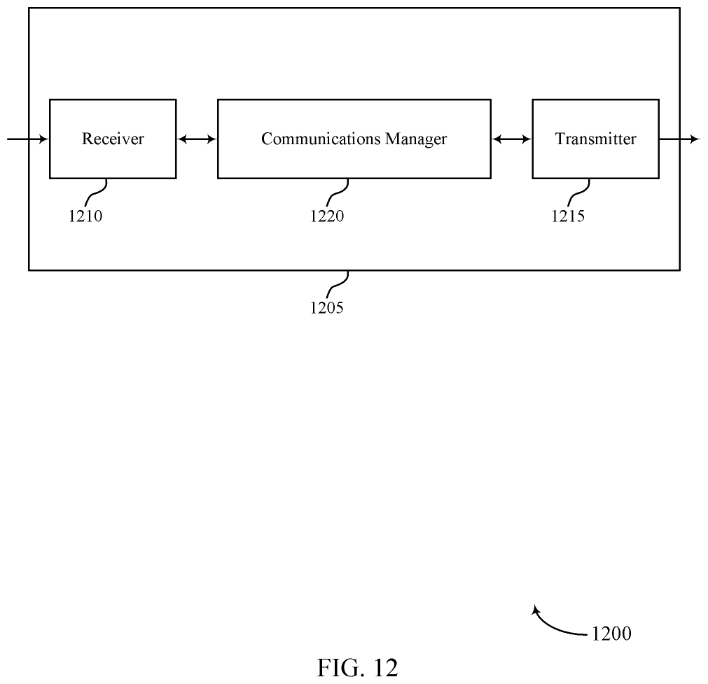

FIG. 12 shows a block diagram 1200 of a device 1205 that supports techniques for baseband frequency shifting in accordance with one or more aspects of the present disclosure. The device 1205 may be an example of aspects of a network entity 105, as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled (e.g., operatively, communicatively, functionally, electronically, or electrically) with a modem.

The communications manager 1220, the receiver 1210, the transmitter 1215, or various combinations thereof or various components thereof may be examples of means for performing various aspects of techniques for baseband frequency shifting, as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware, software (e.g., executed by a processor), or any combination thereof. The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled (e.g., operatively, communicatively, functionally, electronically, or electrically) with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in hardware, software (e.g., executed by a processor), or any combination thereof. If implemented in code executed by a processor, the functions of the communications manager 1220, the receiver 1210, the transmitter 1215, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations, as described herein.

The communications manager 1220 may support wireless communication at the device 1205 in accordance with examples disclosed herein. For example, the communications manager 1220 may be configured as or otherwise support a means for obtaining (from the receiver 1210) an indication of a baseband frequency shift type supported by a UE for backscatter communications, where the baseband frequency shift type includes one or both of a single-side frequency shift or a double-side frequency shift. The communications manager 1220 may be configured as or otherwise support a means for outputting (to the transmitter 1215) a control message that indicates an FDRA for backscatter communications at the UE, where the FDRA corresponds to the baseband frequency shift type supported by the UE. The communications manager 1220 may be configured as or otherwise support a means for obtaining (from the receiver 1210) one or more backscatter communications based on the FDRA indicated by the control message, where the one or more backscatter communications are frequency shifted according to the baseband frequency shift type supported by the UE.

By including or configuring the communications manager 1220 in accordance with examples, as described herein, the device 1205 (e.g., a processor controlling or otherwise coupled (e.g., operatively, communicatively, functionally, electronically, or electrically) with the receiver 1210, the transmitter 1215, the communications manager 1220, or a combination thereof) may support techniques for more efficient utilization of communication resources by reducing the communication resource overhead associated with an FDRA for backscatter communications at a passive UE.

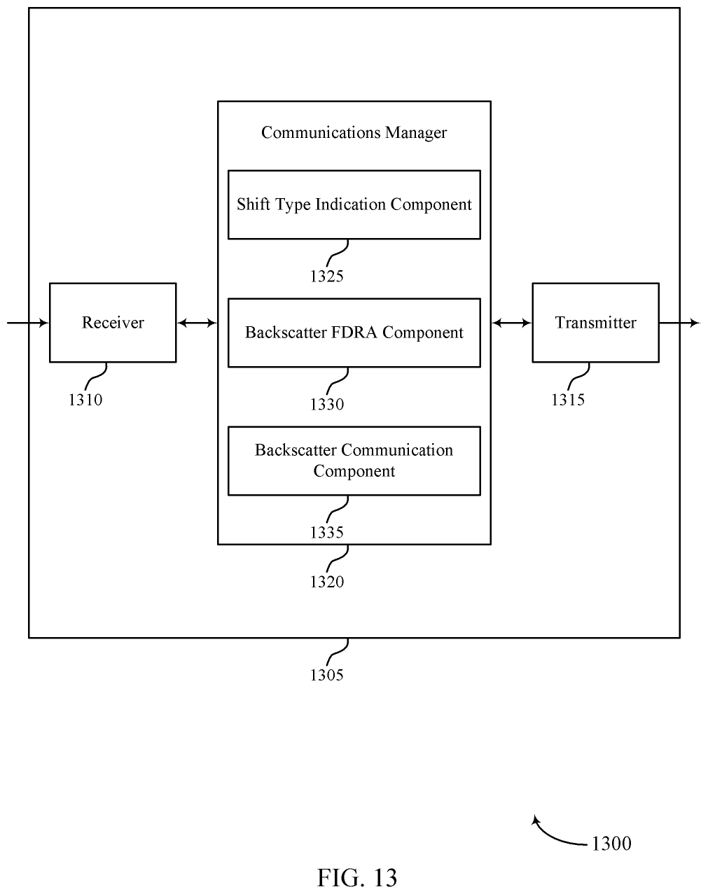

FIG. 13 shows a block diagram 1300 of a device 1305 that supports techniques for baseband frequency shifting in accordance with one or more aspects of the present disclosure. The device 1305 may be an example of aspects of a device 1205 or a network entity 105, as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled (e.g., operatively, communicatively, functionally, electronically, or electrically) with a modem.

The device 1305, or various components thereof, may be an example of means for performing various aspects of techniques for baseband frequency shifting, as described herein. For example, the communications manager 1320 may include a shift type indication component 1325, a backscatter FDRA component 1330, a backscatter communication component 1335, or any combination thereof. The communications manager 1320 may be an example of aspects of a communications manager 1220, as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations, as described herein.

The communications manager 1320 may support wireless communication at the device 1305 in accordance with examples disclosed herein. The shift type indication component 1325 may be configured as or otherwise support a means for obtaining (from the receiver 1310) an indication of a baseband frequency shift type supported by a UE for backscatter communications, where the baseband frequency shift type includes one or both of a single-side frequency shift or a double-side frequency shift. The backscatter FDRA component 1330 may be configured as or otherwise support a means for outputting (to the transmitter 1315) a control message that indicates an FDRA for backscatter communications at the UE, where the FDRA corresponds to the baseband frequency shift type supported by the UE. The backscatter communication component 1335 may be configured as or otherwise support a means for obtaining (from the receiver 1310) one or more backscatter communications based on the FDRA indicated by the control message, where the one or more backscatter communications are frequency shifted according to the baseband frequency shift type supported by the UE.

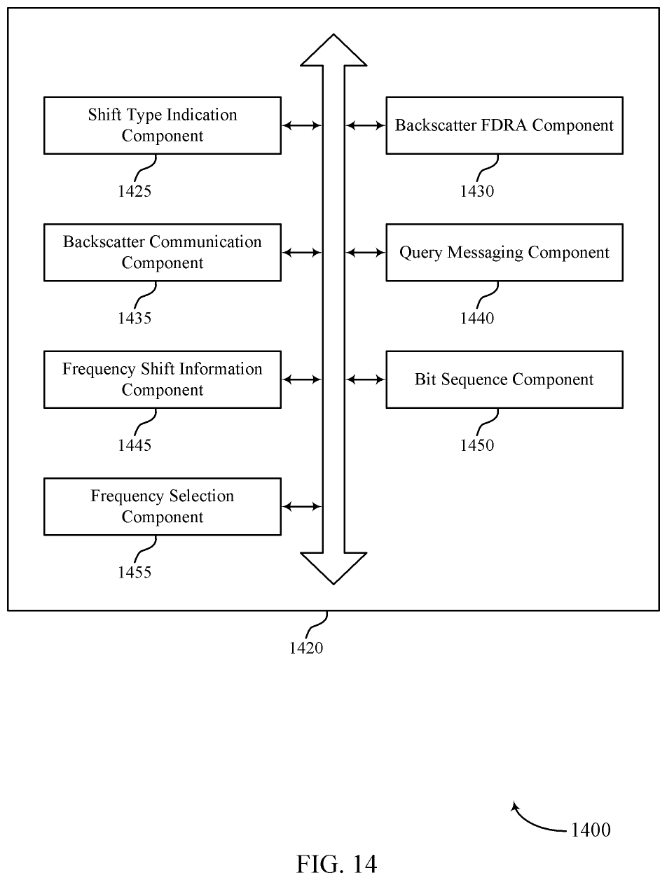

FIG. 14 shows a block diagram 1400 of a communications manager 1420 that supports techniques for baseband frequency shifting in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of the techniques described herein. For example, the communications manager 1420 may include a shift type indication component 1425, a backscatter FDRA component 1430, a backscatter communication component 1435, a query messaging component 1440, a frequency shift information component 1445, a bit sequence component 1450, a frequency selection component 1455, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples disclosed herein. The shift type indication component 1425 may be configured as or otherwise support a means for obtaining an indication of a baseband frequency shift type supported by a UE for backscatter communications, where the baseband frequency shift type includes one or both of a single-side frequency shift or a double-side frequency shift. The backscatter FDRA component 1430 may be configured as or otherwise support a means for outputting a control message that indicates an FDRA for backscatter communications at the UE, where the FDRA corresponds to the baseband frequency shift type supported by the UE. The backscatter communication component 1435 may be configured as or otherwise support a means for obtaining one or more backscatter communications based on the FDRA indicated by the control message, where the one or more backscatter communications are frequency shifted according to the baseband frequency shift type supported by the UE.

In some examples, to support obtaining the indication of the baseband frequency shift type, the shift type indication component 1425 may be configured as or otherwise support a means for obtaining a report that indicates a set of baseband frequencies supported by the UE in connection with the baseband frequency shift type supported by the UE.

In some examples, the frequency selection component 1455 may be configured as or otherwise support a means for selecting a baseband frequency from the set of baseband frequencies indicated by the report. In some examples, the frequency selection component 1455 may be configured as or otherwise support a means for outputting an indication of the selected baseband frequency, where the one or more backscatter communications are frequency shifted according to the selected baseband frequency.

In some examples, the backscatter communication component 1435 may be configured as or otherwise support a means for obtaining at least one backscatter communication based on a default FDRA prior to obtaining the report, where the at least one backscatter communication is frequency shifted according to the baseband frequency shift type supported by the UE.

In some examples, the backscatter FDRA component 1430 may be configured as or otherwise support a means for updating a default FDRA for the UE based on the report. In some examples, the query messaging component 1440 may be configured as or otherwise support a means for outputting a query message associated with a double-side frequency shift type or a single-side frequency shift type, where obtaining the indication of the baseband frequency shift type supported by the UE is based on the query message.

In some examples, to support outputting the control message, the frequency shift information component 1445 may be configured as or otherwise support a means for outputting an indication of frequency shift information for different frequency shift values or different frequency shift types supported by other UEs, where the frequency shift information indicates one or more of a frequency, a frequency index, a frequency shift type, an index associated with a frequency shift type, or a sign of the frequency shift type used for backscatter communications at the other UEs.

In some examples, the bit sequence component 1450 may be configured as or otherwise support a means for obtaining a first portion of a bit sequence that is frequency shifted according to a negative single-side frequency shift. In some examples, the bit sequence component 1450 may be configured as or otherwise support a means for obtaining a second portion of the bit sequence that is frequency shifted according to a positive single-side frequency shift, where the bit sequence includes data or control information.

In some examples, the bit sequence component 1450 may be configured as or otherwise support a means for decoding the bit sequence based on a first received power corresponding to the first portion of the bit sequence and on a second received power corresponding to the second portion of the bit sequence.

In some examples, the backscatter FDRA component 1430 may be configured as or otherwise support a means for outputting a second control message that indicates a second FDRA for backscatter communications at a second UE, where at least a portion of the second FDRA overlaps with the FDRA indicated by the control message.

In some examples, to support obtaining the one or more backscatter communications, the backscatter communication component 1435 may be configured as or otherwise support a means for obtaining a first backscatter communication based on the FDRA for backscatter communications at the UE, where the first backscatter communication is frequency shifted according to a single-side frequency shift with a frequency shift value. In some examples, to support obtaining the one or more backscatter communications, the backscatter communication component 1435 may be configured as or otherwise support a means for obtaining a second backscatter communication based on the second FDRA for backscatter communications at the second UE, where the second backscatter communication is frequency shifted according to a double-side frequency shift with the frequency shift value.

In some examples, the backscatter communication component 1435 may be configured as or otherwise support a means for decoding a first portion of the second backscatter communication that is frequency shifted according to the double-side frequency shift. In some examples, the backscatter communication component 1435 may be configured as or otherwise support a means for decoding the first backscatter communication that is frequency shifted according to the single-side frequency shift by subtracting a second portion of the second backscatter communication from the first backscatter communication, where the first backscatter communication overlaps with the second portion of the second backscatter communication in a time domain and a frequency domain.

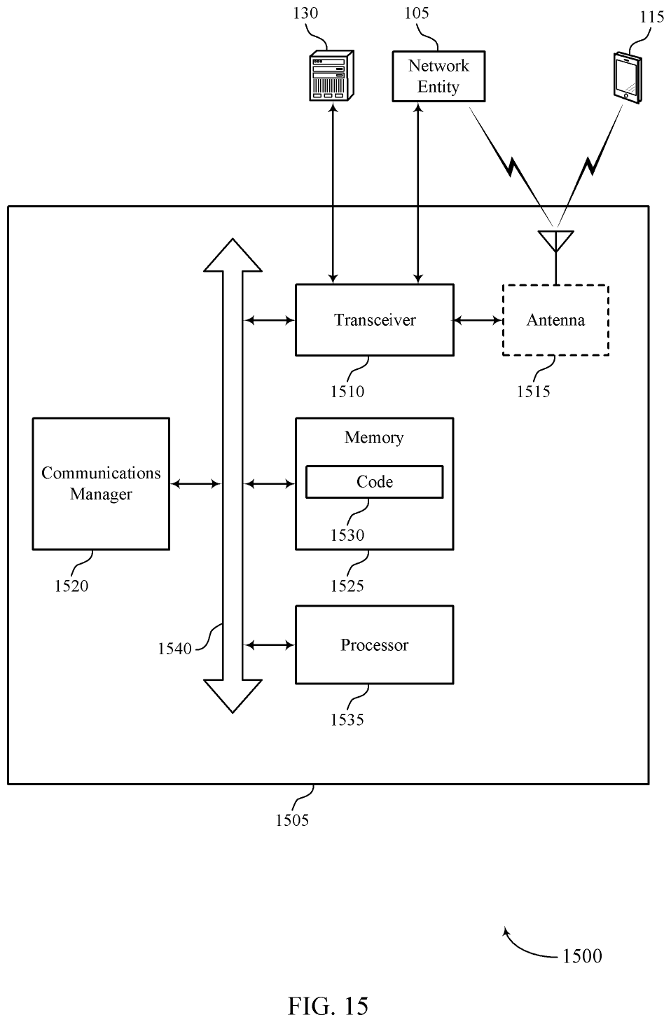

FIG. 15 shows a diagram of a system 1500 including a device 1505 that supports techniques for baseband frequency shifting in accordance with one or more aspects of the present disclosure. The device 1505 may be an example of or include the components of a device 1205, a device 1305, or a network entity 105, as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both, as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. The transceiver 1510, or the transceiver 1510 and one or more antennas 1515 or wired interfaces, where applicable, may be an example of a transmitter 1215, a transmitter 1315, a receiver 1210, a receiver 1310, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting techniques for baseband frequency shifting). For example, the device 1505 or a component of the device 1505 may include a processor 1535 and memory 1525 coupled (e.g., operatively, communicatively, functionally, electronically, or electrically) with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at the device 1505 in accordance with examples disclosed herein. For example, the communications manager 1520 may be configured as or otherwise support a means for obtaining (from the transceiver 1510) an indication of a baseband frequency shift type supported by a UE for backscatter communications, where the baseband frequency shift type includes one or both of a single-side frequency shift or a double-side frequency shift. The communications manager 1520 may be configured as or otherwise support a means for outputting (to the transceiver 1510) a control message that indicates an FDRA for backscatter communications at the UE, where the FDRA corresponds to the baseband frequency shift type supported by the UE. The communications manager 1520 may be configured as or otherwise support a means for obtaining (from the transceiver 1510) one or more backscatter communications based on the FDRA indicated by the control message, where the one or more backscatter communications are frequency shifted according to the baseband frequency shift type supported by the UE.

By including or configuring the communications manager 1520 in accordance with examples, as described herein, the device 1505 may support techniques for greater spectral efficiency and reduced communication resource overhead. More specifically, the described techniques may enable a passive UE to signal support for different frequency shift types and baseband frequencies. The device 1505 may use this information to select or adjust an FDRA for backscatter communications at the passive UE. Allocating frequency resources according to frequency shift type may improve the spectral efficiency of backscatter communications at the passive UE by reducing the communication resource overhead of the associated FDRA.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the processor 1535, the memory 1525, the code 1530, the transceiver 1510, or any combination thereof. For example, the code 1530 may include instructions executable by the processor 1535 to cause the device 1505 to perform various aspects of techniques for baseband frequency shifting, as described herein, or the processor 1535 and the memory 1525 may be otherwise configured to perform or support such operations.

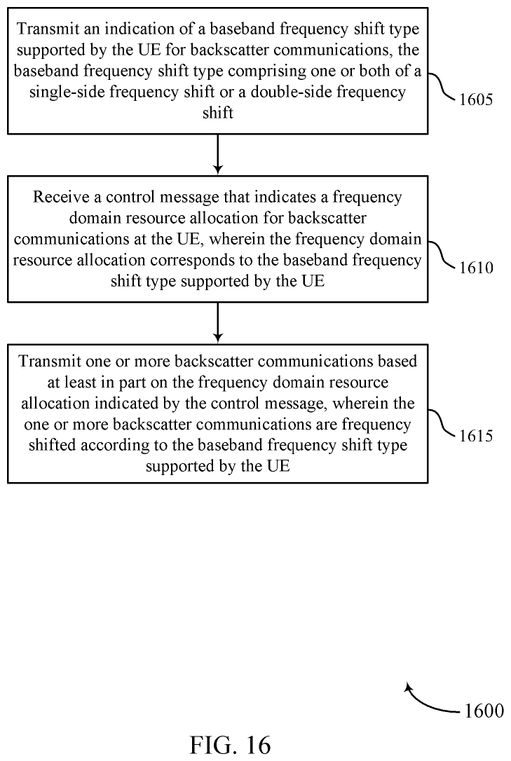

FIG. 16 shows a flowchart illustrating a method 1600 that supports techniques for baseband frequency shifting in accordance with one or more aspects of the present disclosure. The operations of the method 1600 may be implemented by a UE or components of a UE, as described herein. For example, the operations of the method 1600 may be performed by a UE 115, as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include transmitting an indication of a baseband frequency shift type supported by the UE for backscatter communications, the baseband frequency shift type comprising one or both of a single-side frequency shift or a double-side frequency shift. The operations of 1605 may be performed in accordance with examples disclosed herein. In some examples, aspects of the operations of 1605 may be performed by a shift type component 1025, as described with reference to FIG. 10.

At 1610, the method may include receiving a control message that indicates a frequency domain resource allocation for backscatter communications at the UE, wherein the frequency domain resource allocation corresponds to the baseband frequency shift type supported by the UE. The operations of 1610 may be performed in accordance with examples disclosed herein. In some examples, aspects of the operations of 1610 may be performed by a control message component 1030, as described with reference to FIG. 10.

At 1615, the method may include transmitting one or more backscatter communications based at least in part on the frequency domain resource allocation indicated by the control message, wherein the one or more backscatter communications are frequency shifted according to the baseband frequency shift type supported by the UE. The operations of 1615 may be performed in accordance with examples disclosed herein. In some examples, aspects of the operations of 1615 may be performed by a backscattering component 1035, as described with reference to FIG. 10.

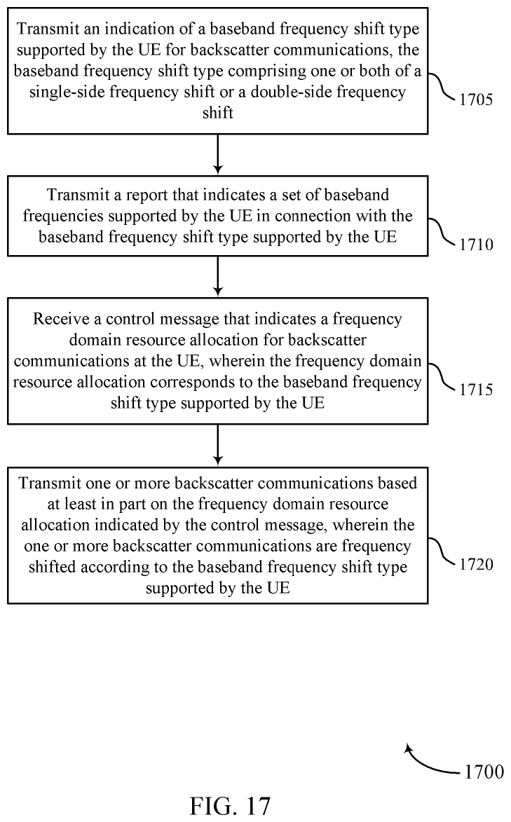

FIG. 17 shows a flowchart illustrating a method 1700 that supports techniques for baseband frequency shifting in accordance with one or more aspects of the present disclosure. The operations of the method 1700 may be implemented by a UE or components of a UE, as described herein. For example, the operations of the method 1700 may be performed by a UE 115, as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include transmitting an indication of a baseband frequency shift type supported by the UE for backscatter communications, the baseband frequency shift type comprising one or both of a single-side frequency shift or a double-side frequency shift. The operations of 1705 may be performed in accordance with examples disclosed herein. In some examples, aspects of the operations of 1705 may be performed by a shift type component 1025, as described with reference to FIG. 10.

At 1710, the method may include transmitting a report that indicates a set of baseband frequencies supported by the UE in connection with the baseband frequency shift type supported by the UE. The operations of 1710 may be performed in accordance with examples disclosed herein. In some examples, aspects of the operations of 1710 may be performed by a shift type component 1025, as described with reference to FIG. 10.

At 1715, the method may include receiving a control message that indicates a frequency domain resource allocation for backscatter communications at the UE, wherein the frequency domain resource allocation corresponds to the baseband frequency shift type supported by the UE. The operations of 1715 may be performed in accordance with examples disclosed herein. In some examples, aspects of the operations of 1715 may be performed by a control message component 1030, as described with reference to FIG. 10.

At 1720, the method may include transmitting one or more backscatter communications based at least in part on the frequency domain resource allocation indicated by the control message, wherein the one or more backscatter communications are frequency shifted according to the baseband frequency shift type supported by the UE. The operations of 1720 may be performed in accordance with examples disclosed herein. In some examples, aspects of the operations of 1720 may be performed by a backscattering component 1035, as described with reference to FIG. 10.

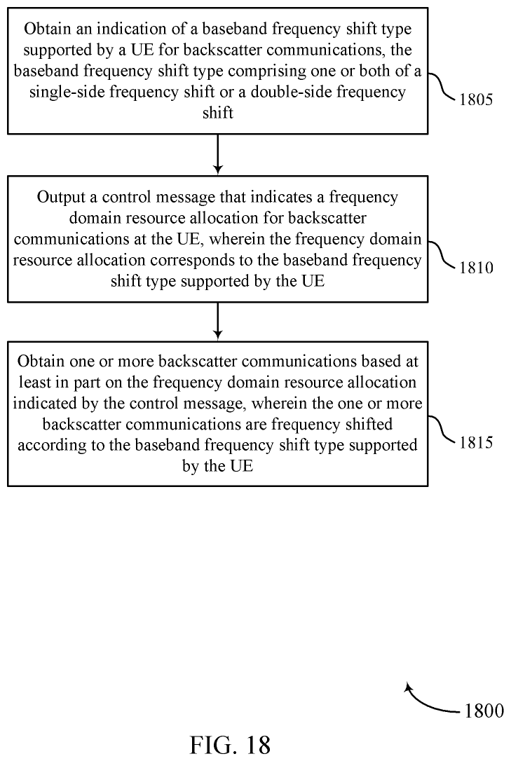

FIG. 18 shows a flowchart illustrating a method 1800 that supports techniques for baseband frequency shifting in accordance with one or more aspects of the present disclosure. The operations of the method 1800 may be implemented by a network entity or components of a network entity, as described herein. For example, the operations of the method 1800 may be performed by a network entity 105, as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include obtaining an indication of a baseband frequency shift type supported by a UE for backscatter communications, the baseband frequency shift type comprising one or both of a single-side frequency shift or a double-side frequency shift. The operations of 1805 may be performed in accordance with examples disclosed herein. In some examples, aspects of the operations of 1805 may be performed by a shift type indication component 1425, as described with reference to FIG. 14.

At 1810, the method may include outputting a control message that indicates a frequency domain resource allocation for backscatter communications at the UE, wherein the frequency domain resource allocation corresponds to the baseband frequency shift type supported by the UE. The operations of 1810 may be performed in accordance with examples disclosed herein. In some examples, aspects of the operations of 1810 may be performed by a backscatter FDRA component 1430, as described with reference to FIG. 14.

At 1815, the method may include obtaining one or more backscatter communications based at least in part on the frequency domain resource allocation indicated by the control message, wherein the one or more backscatter communications are frequency shifted according to the baseband frequency shift type supported by the UE. The operations of 1815 may be performed in accordance with examples disclosed herein. In some examples, aspects of the operations of 1815 may be performed by a backscatter communication component 1435, as described with reference to FIG. 14.

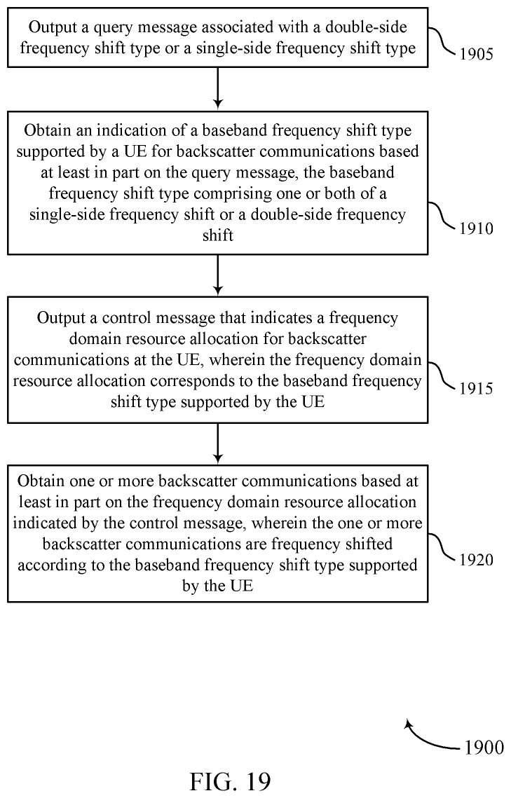

FIG. 19 shows a flowchart illustrating a method 1900 that supports techniques for baseband frequency shifting in accordance with one or more aspects of the present disclosure. The operations of the method 1900 may be implemented by a network entity or components of a network entity, as described herein. For example, the operations of the method 1900 may be performed by a network entity 105, as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include outputting a query message associated with a double-side frequency shift type or a single-side frequency shift type. The operations of 1905 may be performed in accordance with examples disclosed herein. In some examples, aspects of the operations of 1905 may be performed by a query messaging component 1440, as described with reference to FIG. 14.

At 1910, the method may include obtaining an indication of a baseband frequency shift type supported by a UE for backscatter communications based at least in part on the query message, the baseband frequency shift type comprising one or both of a single-side frequency shift or a double-side frequency shift. The operations of 1910 may be performed in accordance with examples disclosed herein. In some examples, aspects of the operations of 1910 may be performed by a shift type indication component 1425, as described with reference to FIG. 14.

At 1915, the method may include outputting a control message that indicates a frequency domain resource allocation for backscatter communications at the UE, wherein the frequency domain resource allocation corresponds to the baseband frequency shift type supported by the UE. The operations of 1915 may be performed in accordance with examples disclosed herein. In some examples, aspects of the operations of 1915 may be performed by a backscatter FDRA component 1430, as described with reference to FIG. 14.

At 1920, the method may include obtaining one or more backscatter communications based at least in part on the frequency domain resource allocation indicated by the control message, wherein the one or more backscatter communications are frequency shifted according to the baseband frequency shift type supported by the UE. The operations of 1920 may be performed in accordance with examples disclosed herein. In some examples, aspects of the operations of 1920 may be performed by a backscatter communication component 1435, as described with reference to FIG. 14.

The following provides an overview of aspects of the present disclosure:

Aspect 1: A method for wireless communication at a UE, comprising: transmitting an indication of a baseband frequency shift type supported by the UE for backscatter communications, the baseband frequency shift type comprising one or both of a single-side frequency shift or a double-side frequency shift; receiving a control message that indicates a frequency domain resource allocation for backscatter communications at the UE, wherein the frequency domain resource allocation corresponds to the baseband frequency shift type supported by the UE; and transmitting one or more backscatter communications based at least in part on the frequency domain resource allocation indicated by the control message, wherein the one or more backscatter communications are frequency shifted according to the baseband frequency shift type supported by the UE.

Aspect 2: The method of aspect 1, wherein transmitting the indication of the baseband frequency shift type supported by the UE comprises: transmitting a report that indicates a set of baseband frequencies supported by the UE in connection with the baseband frequency shift type supported by the UE.

Aspect 3: The method of aspect 2, further comprising: receiving an indication of a selected baseband frequency from the set of baseband frequencies indicated by the report, wherein the one or more backscatter communications are frequency shifted according to the selected baseband frequency.

Aspect 4: The method of any of aspects 2 through 3, further comprising: transmitting at least one backscatter communication based at least in part on a default frequency domain resource allocation prior to transmitting the report, wherein the at least one backscatter communication is frequency shifted according to the baseband frequency shift type supported by the UE.

Aspect 5: The method of any of aspects 2 through 4, further comprising: receiving downlink control information that indicates an updated frequency domain resource allocation for backscatter communications at the UE, wherein the updated frequency domain resource allocation is based at least in part on the report.

Aspect 6: The method of any of aspects 2 through 5, wherein the report indicates start frequencies associated with the set of baseband frequencies, step frequencies associated with the set of baseband frequencies, stop frequencies associated with the set of baseband frequencies, each frequency in the set of baseband frequencies, or a combination thereof.

Aspect 7: The method of any of aspects 2 through 6, wherein the report is transmitted via a default baseband frequency; and the set of baseband frequencies indicated by the report is associated with a baseband frequency source type of the UE.

Aspect 8: The method of any of aspects 1 through 7, further comprising: receiving downlink control information that indicates a default frequency domain resource allocation for backscatter communications at the UE.

Aspect 9: The method of any of aspects 1 through 8, further comprising: receiving a query message associated with a double-side frequency shift type or a single-side frequency shift type, wherein transmitting the indication of the baseband frequency shift type supported by the UE is based at least in part on the query message.

Aspect 10: The method of any of aspects 1 through 9, wherein receiving the control message comprises: receiving an indication of frequency shift information for different frequency shift values or different frequency shift types supported by other UEs, wherein the frequency shift information indicates one or more of a frequency, a frequency index, a frequency shift type, an index associated with a frequency shift type, or a sign of the frequency shift type used for backscatter communications at the other UEs.

Aspect 11: The method of any of aspects 1 through 10, wherein transmitting the one or more backscatter communications comprises: transmitting, in accordance with a frequency shift hopping scheme, a first backscatter communication that is frequency shifted according to a negative single-side frequency shift and a second backscatter communication that is frequency shifted according to a positive single-side frequency shift.

Aspect 12: The method of any of aspects 1 through 11, wherein transmitting the one or more backscatter communications comprises: transmitting a first portion of a bit sequence that is frequency shifted according to a negative single-side frequency shift; and transmitting a second portion of the bit sequence that is frequency shifted according to a positive single-side frequency shift, wherein the bit sequence comprises data or control information.

Aspect 13: The method of any of aspects 1 through 12, wherein the frequency domain resource allocation indicates a frequency hopping scheme for backscatter communications at the UE.

Aspect 14: The method of any of aspects 1 through 13, wherein transmitting the one or more backscatter communications comprises: receiving a downlink shared channel transmission via a downlink baseband frequency; and signaling the one or more backscatter communications by frequency shifting the downlink shared channel transmission with respect to the downlink baseband frequency and modifying one or both of an amplitude or a phase of the downlink shared channel transmission.

Aspect 15: The method of any of aspects 1 through 14, wherein transmitting the one or more backscatter communications comprises: receiving an uplink shared channel transmission via an uplink baseband frequency; and signaling the one or more backscatter communications by frequency shifting the uplink shared channel transmission with respect to the uplink baseband frequency and modifying one or both of an amplitude or a phase of the uplink shared channel transmission.

Aspect 16: The method of any of aspects 1 through 8, wherein the indication of the baseband frequency shift type is transmitted in response to a trigger message.

Aspect 17: A method for wireless communication at a network entity, comprising: obtaining an indication of a baseband frequency shift type supported by a UE for backscatter communications, the baseband frequency shift type comprising one or both of a single-side frequency shift or a double-side frequency shift; outputting a control message that indicates a frequency domain resource allocation for backscatter communications at the UE, wherein the frequency domain resource allocation corresponds to the baseband frequency shift type supported by the UE; and obtaining one or more backscatter communications based at least in part on the frequency domain resource allocation indicated by the control message, wherein the one or more backscatter communications are frequency shifted according to the baseband frequency shift type supported by the UE.

Aspect 18: The method of aspect 17, wherein obtaining the indication of the baseband frequency shift type comprises: obtaining a report that indicates a set of baseband frequencies supported by the UE in connection with the baseband frequency shift type supported by the UE.

Aspect 19: The method of aspect 18, further comprising: selecting a baseband frequency from the set of baseband frequencies indicated by the report; and outputting an indication of the selected baseband frequency, wherein the one or more backscatter communications are frequency shifted according to the selected baseband frequency.

Aspect 20: The method of any of aspects 18 through 19, further comprising: obtaining at least one backscatter communication based at least in part on a default frequency domain resource allocation prior to obtaining the report, wherein the at least one backscatter communication is frequency shifted according to the baseband frequency shift type supported by the UE.

Aspect 21: The method of any of aspects 18 through 20, further comprising: updating a default frequency domain resource allocation for the UE based at least in part on the report.

Aspect 22: The method of any of aspects 17 through 21, further comprising: outputting a query message associated with a double-side frequency shift type or a single-side frequency shift type, wherein obtaining the indication of the baseband frequency shift type supported by the UE is based at least in part on the query message.

Aspect 23: The method of any of aspects 17 through 22, wherein outputting the control message comprises: outputting an indication of frequency shift information for different frequency shift values or different frequency shift types supported by other UEs, wherein the frequency shift information indicates one or more of a frequency, a frequency index, a frequency shift type, an index associated with a frequency shift type, or a sign of the frequency shift type used for backscatter communications at the other UEs.

Aspect 24: The method of any of aspects 17 through 23, further comprising: obtaining a first portion of a bit sequence that is frequency shifted according to a negative single-side frequency shift; and obtaining a second portion of the bit sequence that is frequency shifted according to a positive single-side frequency shift, wherein the bit sequence comprises data or control information.

Aspect 25: The method of aspect 24, further comprising: decoding the bit sequence based at least in part on a first received power corresponding to the first portion of the bit sequence and on a second received power corresponding to the second portion of the bit sequence.

Aspect 26: The method of any of aspects 17 through 25, further comprising: outputting a second control message that indicates a second frequency domain resource allocation for backscatter communications at a second UE, wherein at least a portion of the second frequency domain resource allocation overlaps with the frequency domain resource allocation indicated by the control message.

Aspect 27: The method of aspect 26, wherein obtaining the one or more backscatter communications comprises: obtaining a first backscatter communication based at least in part on the frequency domain resource allocation for backscatter communications at the UE, wherein the first backscatter communication is frequency shifted according to a single-side frequency shift with a frequency shift value; and obtaining a second backscatter communication based at least in part on the second frequency domain resource allocation for backscatter communications at the second UE, wherein the second backscatter communication is frequency shifted according to a double-side frequency shift with the frequency shift value.

Aspect 28: The method of aspect 27, further comprising: decoding a first portion of the second backscatter communication that is frequency shifted according to the double-side frequency shift; and decoding the first backscatter communication that is frequency shifted according to the single-side frequency shift by subtracting a second portion of the second backscatter communication from the first backscatter communication, wherein the first backscatter communication overlaps with the second portion of the second backscatter communication in a time domain and a frequency domain.

Aspect 29: An apparatus for wireless communication at a UE, comprising: at least one processor; and memory coupled to the at least one processor, the memory storing instructions executable by the at least one processor to cause the UE to perform a method of any of aspects 1 through 16.

Aspect 30: An apparatus for wireless communication at a UE, comprising: at least one means for performing a method of any of aspects 1 through 16.

Aspect 31: A non-transitory computer-readable medium storing code for wireless communication at a UE, the code comprising instructions executable by at least one processor to cause the UE to perform a method of any of aspects 1 through 16.

Aspect 32: An apparatus for wireless communication at a network entity, comprising: at least one processor; and memory coupled to the at least one processor, the memory storing instructions executable by the at least one processor to cause the network entity to perform a method of any of aspects 17 through 28.

Aspect 33: An apparatus for wireless communication at a network entity, comprising: at least one means for performing a method of any of aspects 17 through 28.

Aspect 34: A non-transitory computer-readable medium storing code for wireless communication at a network entity, the code comprising instructions executable by at least one processor to cause the network entity to perform a method of any of aspects 17 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software (e.g., executed by a processor), or any combination thereof. Software shall be construed broadly to mean instructions, instruction sets, code, code segments, program code, programs, sub-programs, software modules, applications, software applications, software packages, routines, sub-routines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining, among other examples. Also, “determining” can include receiving (such as receiving information), or accessing (such as accessing data in a memory), among other examples. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled to the at least one processor, the memory storing instructions executable by the at least one processor to cause the UE to:
transmit an indication of a baseband frequency shift type supported by the UE for backscatter communications, the baseband frequency shift type comprising one or both of a single-side frequency shift or a double-side frequency shift;
receive a control message that indicates a frequency domain resource allocation for backscatter communications at the UE, wherein the frequency domain resource allocation corresponds to the baseband frequency shift type supported by the UE; and
transmit one or more backscatter communications based at least in part on the frequency domain resource allocation indicated by the control message, wherein the one or more backscatter communications are frequency shifted according to the baseband frequency shift type supported by the UE.

2. The apparatus of claim 1, wherein the instructions to transmit the indication of the baseband frequency shift type supported by the UE are executable by the at least one processor to cause the UE to:
transmit a report that indicates a set of baseband frequencies supported by the UE in connection with the baseband frequency shift type supported by the UE.

3. The apparatus of claim 2, wherein the instructions are further executable by the at least one processor to cause the UE to:
receive an indication of a selected baseband frequency from the set of baseband frequencies indicated by the report, wherein the one or more backscatter communications are frequency shifted according to the selected baseband frequency.

4. The apparatus of claim 2, wherein the instructions are further executable by the at least one processor to cause the UE to:
transmit at least one backscatter communication based at least in part on a default frequency domain resource allocation prior to transmitting the report, wherein the at least one backscatter communication is frequency shifted according to the baseband frequency shift type supported by the UE.

5. The apparatus of claim 2, wherein the instructions are further executable by the at least one processor to cause the UE to:
receive downlink control information that indicates an updated frequency domain resource allocation for backscatter communications at the UE, wherein the updated frequency domain resource allocation is based at least in part on the report.

6. The apparatus of claim 2, wherein the report indicates start frequencies associated with the set of baseband frequencies, step frequencies associated with the set of baseband frequencies, stop frequencies associated with the set of baseband frequencies, each frequency in the set of baseband frequencies, or a combination thereof.

7. The apparatus of claim 2, wherein:
the report is transmitted via a default baseband frequency; and
the set of baseband frequencies indicated by the report is associated with a baseband frequency source type of the UE.

8. The apparatus of claim 1, wherein the instructions are further executable by the at least one processor to cause the UE to:
receive downlink control information that indicates a default frequency domain resource allocation for backscatter communications at the UE.

9. The apparatus of claim 1, wherein the instructions are further executable by the at least one processor to cause the UE to:
receive a query message associated with a double-side frequency shift type or a single-side frequency shift type, wherein transmitting the indication of the baseband frequency shift type supported by the UE is based at least in part on the query message.

10. The apparatus of claim 1, wherein the instructions to receive the control message are executable by the at least one processor to cause the UE to:
receive an indication of frequency shift information for different frequency shift values or different frequency shift types supported by other UEs, wherein the frequency shift information indicates one or more of a frequency, a frequency index, a frequency shift type, an index associated with a frequency shift type, or a sign of the frequency shift type used for backscatter communications at the other UEs.

11. The apparatus of claim 1, wherein the instructions to transmit the one or more backscatter communications are executable by the at least one processor to cause the UE to:
transmit, in accordance with a frequency shift hopping scheme, a first backscatter communication that is frequency shifted according to a negative single-side frequency shift and a second backscatter communication that is frequency shifted according to a positive single-side frequency shift.

12. The apparatus of claim 1, wherein the instructions to transmit the one or more backscatter communications are executable by the at least one processor to cause the UE to:
transmit a first portion of a bit sequence that is frequency shifted according to a negative single-side frequency shift; and
transmit a second portion of the bit sequence that is frequency shifted according to a positive single-side frequency shift, wherein the bit sequence comprises data or control information.

13. The apparatus of claim 1, wherein the frequency domain resource allocation indicates a frequency hopping scheme for backscatter communications at the UE.

14. The apparatus of claim 1, wherein the instructions to transmit the one or more backscatter communications are executable by the at least one processor to cause the UE to:
receive a downlink shared channel transmission via a downlink baseband frequency; and
signal the one or more backscatter communications by frequency shifting the downlink shared channel transmission with respect to the downlink baseband frequency and modifying one or both of an amplitude or a phase of the downlink shared channel transmission.

15. The apparatus of claim 1, wherein the instructions to transmit the one or more backscatter communications are executable by the at least one processor to cause the UE to:
receive an uplink shared channel transmission via an uplink baseband frequency; and
signal the one or more backscatter communications by frequency shifting the uplink shared channel transmission with respect to the uplink baseband frequency and modifying one or both of an amplitude or a phase of the uplink shared channel transmission.

16. The apparatus of claim 1, wherein the indication of the baseband frequency shift type is transmitted in response to a trigger message.

17. An apparatus for wireless communication at a network entity, comprising:
at least one processor; and
memory coupled to the at least one processor, the memory storing instructions executable by the at least one processor to cause the network entity to:
obtain an indication of a baseband frequency shift type supported by a user equipment (UE) for backscatter communications, the baseband frequency shift type comprising one or both of a single-side frequency shift or a double-side frequency shift;
output a control message that indicates a frequency domain resource allocation for backscatter communications at the UE, wherein the frequency domain resource allocation corresponds to the baseband frequency shift type supported by the UE; and
obtain one or more backscatter communications based at least in part on the frequency domain resource allocation indicated by the control message, wherein the one or more backscatter communications are frequency shifted according to the baseband frequency shift type supported by the UE.

18. The apparatus of claim 17, wherein the instructions to obtain the indication of the baseband frequency shift type are executable by the at least one processor to cause the network entity to:
obtain a report that indicates a set of baseband frequencies supported by the UE in connection with the baseband frequency shift type supported by the UE.

19. The apparatus of claim 18, wherein the instructions are further executable by the at least one processor to cause the network entity to:
select a baseband frequency from the set of baseband frequencies indicated by the report; and
output an indication of the selected baseband frequency, wherein the one or more backscatter communications are frequency shifted according to the selected baseband frequency.

20. The apparatus of claim 18, wherein the instructions are further executable by the at least one processor to cause the network entity to:
obtain at least one backscatter communication based at least in part on a default frequency domain resource allocation prior to obtaining the report, wherein the at least one backscatter communication is frequency shifted according to the baseband frequency shift type supported by the UE.

21. The apparatus of claim 18, wherein the instructions are further executable by the at least one processor to cause the network entity to:
update a default frequency domain resource allocation for the UE based at least in part on the report.

22. The apparatus of claim 17, wherein the instructions are further executable by the at least one processor to cause the network entity to:
output a query message associated with a double-side frequency shift type or a single-side frequency shift type, wherein obtaining the indication of the baseband frequency shift type supported by the UE is based at least in part on the query message.

23. The apparatus of claim 17, wherein the instructions to output the control message are executable by the at least one processor to cause the network entity to:
output an indication of frequency shift information for different frequency shift values or different frequency shift types supported by other UEs, wherein the frequency shift information indicates one or more of a frequency, a frequency index, a frequency shift type, an index associated with a frequency shift type, or a sign of the frequency shift type used for backscatter communications at the other UEs.

24. The apparatus of claim 17, wherein the instructions are further executable by the at least one processor to cause the network entity to:
obtain a first portion of a bit sequence that is frequency shifted according to a negative single-side frequency shift; and
obtain a second portion of the bit sequence that is frequency shifted according to a positive single-side frequency shift, wherein the bit sequence comprises data or control information.

25. The apparatus of claim 24, wherein the instructions are further executable by the at least one processor to cause the network entity to:
decode the bit sequence based at least in part on a first received power corresponding to the first portion of the bit sequence and on a second received power corresponding to the second portion of the bit sequence.

26. The apparatus of claim 17, wherein the instructions are further executable by the at least one processor to cause the network entity to:
output a second control message that indicates a second frequency domain resource allocation for backscatter communications at a second UE, wherein at least a portion of the second frequency domain resource allocation overlaps with the frequency domain resource allocation indicated by the control message.

27. The apparatus of claim 26, wherein the instructions to obtain the one or more backscatter communications are executable by the at least one processor to cause the network entity to:
obtain a first backscatter communication based at least in part on the frequency domain resource allocation for backscatter communications at the UE, wherein the first backscatter communication is frequency shifted according to a single-side frequency shift with a frequency shift value; and
obtain a second backscatter communication based at least in part on the second frequency domain resource allocation for backscatter communications at the second UE, wherein the second backscatter communication is frequency shifted according to a double-side frequency shift with the frequency shift value.

28. The apparatus of claim 27, wherein the instructions are further executable by the at least one processor to cause the network entity to:
decode a first portion of the second backscatter communication that is frequency shifted according to the double-side frequency shift; and
decode the first backscatter communication that is frequency shifted according to the single-side frequency shift by subtracting a second portion of the second backscatter communication from the first backscatter communication, wherein the first backscatter communication overlaps with the second portion of the second backscatter communication in a time domain and a frequency domain.

29. A method for wireless communication at a user equipment (UE), comprising:
transmitting an indication of a baseband frequency shift type supported by the UE for backscatter communications, the baseband frequency shift type comprising one or both of a single-side frequency shift or a double-side frequency shift;
receiving a control message that indicates a frequency domain resource allocation for backscatter communications at the UE, wherein the frequency domain resource allocation corresponds to the baseband frequency shift type supported by the UE; and
transmitting one or more backscatter communications based at least in part on the frequency domain resource allocation indicated by the control message, wherein the one or more backscatter communications are frequency shifted according to the baseband frequency shift type supported by the UE.

30. A method for wireless communication at a network entity, comprising:
obtaining an indication of a baseband frequency shift type supported by a user equipment (UE) for backscatter communications, the baseband frequency shift type comprising one or both of a single-side frequency shift or a double-side frequency shift;
outputting a control message that indicates a frequency domain resource allocation for backscatter communications at the UE, wherein the frequency domain resource allocation corresponds to the baseband frequency shift type supported by the UE; and
obtaining one or more backscatter communications based at least in part on the frequency domain resource allocation indicated by the control message, wherein the one or more backscatter communications are frequency shifted according to the baseband frequency shift type supported by the UE.
